(19) United States
(12) Patent Application Publication
(10) Pub. No.: US 2007/0027636 A1
(43) Pub. Date: Feb. 1, 2007

(54) System and method for using genetic, phentoypic and clinical data to make predictions for clinical or lifestyle decisions

(76) Inventor: Matthew Rabinowitz, Portola Valley, CA (US)

Correspondence Address: Matthew Rabinowitz, 80 Hayfields Road, Portola Valley, CA, 94028, US

(21) Appl. No.: 11/496,982

(22) Filed: Jul. 31, 2006

Related U.S. Application Data
(60) Provisional application No. 60/703,415, filed on Jul. 29, 2005.
(60) Provisional application No. 60/742,305, filed on Dec. 6, 2005.
(60) Provisional application No. 60/754,396, filed on Dec. 29, 2005.
(60) Provisional application No. 60/774,976, filed on Feb. 21, 2006.
(60) Provisional application No. 60/789,506, filed on Apr. 4, 2006.
(60) Provisional application No. 60/817,741, filed on Jun. 30, 2006.

(51) Int. Cl. G06F 19/00; G06Q 50/00

(52) U.S. Cl. 702/20; 705/2

(57) ABSTRACT

Systems and methods for predicting likely phenotypic outcomes using mathematical models and given genetic, phenotypic and/or clinical data of an individual, and also relevant aggregated medical data consisting of genotypic, phenotypic, and/or clinical data from germane patient subpopulations are provided. In one embodiment, support vector machines may be used to create non-linear models, or LASSO techniques may be used to create linear models, both of which are trained using convex optimization techniques to make the models sparse. In another embodiment, phenotypic predictions may be made using models based on contingency tables for genetic data that can be constructed from data available in genomic databases.

### CROSS-REFERENCES TO RELATED APPLICATIONS

This application, under 35 U.S.C. §119(e) claims the benefit of the following U.S. Provisional Patent Applications: Ser. No. 60/703,415, filed Jul. 29th, 2005; Ser. No. 60/742,305, filed Dec. 6, 2005; Ser. No. 60/754,396, filed Dec. 29, 2005; Ser. No. 60/774,976, filed Feb. 21, 2006; Ser. No. 60/789,506, filed Apr. 4, 2006; Ser. No. 60/817,741, filed Jun. 30, 2006; the disclosures thereof are incorporated by reference herein in their entirety.

### FIELD OF THE TECHNOLOGY

The technology disclosed herein relates generally to the field of analyzing, managing and acting upon genetic, phenotypic and clinical information, and using that information to predict phenotypic outcomes of medical decisions. More specifically, it relates to methods and systems which use integrated, validated genetic and phenotypic data from a group of subjects to make better decisions regarding a particular subject.

### BACKGROUND

The current methods by which clinical decisions are made do not make the best possible use of existing information. As medical, biochemical and information technology advance, increasing amounts of data are generated and stored both for individual patients, and also in the context of academic and clinical studies. With the recent upsurge in the amounts of genetic, phenotypic and clinical information available for analysis, much effort has gone into finding clinically relevant correlations to help people lead longer, healthier and more enjoyable lives. Whereas previously clinicians and researchers would concentrate their analysis on a handful of obvious potential factors and use a local store of data, it is becoming clear the potential benefit of being able to leverage data measured by scores of other agents, and using more complex models that can identify previously unsuspected factors which correlate with a given genotype or phenotype. This situation will become considerably more complicated once personal genetic data occupies a more central role in understanding the causes and treatments of diseases and other predispositions of subjects. Within the next decade it may be possible to scan the entire genome of a patient as well as to collect a myriad of phenotypic data points, either for clinical trials, or for the purpose of personalized treatments and or drug assignment.

### SUMMARY

Certain embodiments of the technology disclosed herein describe a system for making accurate predictions of phenotypic outcomes or phenotype susceptibilities for an individual given a set of genetic, phenotypic and or clinical information for the individual. In one aspect, a technique for building linear and nonlinear regression models that can predict phenotype accurately when there are many potential predictors compared to the number of measured outcomes, as is typical of genetic data, is disclosed. In certain examples, the models are trained using convex optimization techniques to perform continuous subset selection of predictors so that one is guaranteed to find the globally optimal parameters for a particular set of data. This feature is particularly advantageous when the model may be complex and may contain many potential predictors such as genetic mutations or gene expression levels. Furthermore, in some examples convex optimization techniques may be used to make the models sparse so that they explain the data in a simple way. This feature enables the trained models to generalize accurately even when the number of potential predictors in the model is large compared to the number of measured outcomes in the training data. These techniques have been published in one of the world's leading bioinformatics journals (Rabinowitz, M., et al., 2006, “Accurate prediction of HIV-1 drug response from the reverse transcriptase and protease amino acid sequences using sparse models created by convex optimization.” Bioinformatics 22(5): 541-9.).

In another aspect, a technique for creating models based on contingency tables that can be constructed from data that is available through publications such as through the OMIM (Online Mendelian Inheritance in Man) database and using data that is available through the HapMap project and other aspects of the human genome project is provided. Certain embodiments of this technique use emerging public data about the association between genes and about association between genes and diseases in order to improve the predictive accuracy of models.

In yet another aspect, a technique by which the best model can be found for the data that is available for a particular patient is disclosed. In this aspect, many different combinations of variables may be examined, together with many different modeling techniques, and that combination may be chosen which will produce the best prediction for an individual subject based on cross-validation with testing data from other subjects.

While certain illustrative embodiments disclosed herein focus on genetic data from human subjects, and provide specific embodiments for people suffering from cancer or HIV, or for people who seek to understand their susceptibility to diseases such as Alzheimer's or Myocardial Infarction, it should be noted that the methods disclosed apply to the genetic data of a range of organisms, in a range of numerous, different contexts. The techniques described herein for phenotypic prediction and drug response prediction may be relevant in the context of the treatment of a variety of cancers, genetic illnesses, bacterial, fungal or viral infections, as well as in making phenotypic predictions for individuals to enhance clinical and lifestyle decisions. Furthermore, the system can be used to determine the likelihood of particular phenotypic outcomes given genetic data, specifically SNP (single nucleotide polymorphism) data of an embryo (pre-implantation) in the context of IVF, or of a fetus in the context of non-invasive or invasive prenatal diagnosis including amniocentesis.

In one embodiment, the predictive models may be applied to genetic data for a particular individual that has been stored in a standardized computable format. The individual may describe particular issues that are relevant to them, or the system may automatically determine which phenotypic susceptibilities are relevant to that individual. As new research data becomes available on disease-gene associations, treatments, or lifestyle habits, the individual can be notified of the impact of this information on their decisions and habits, based on predictive models developed from the aggregated genomic and clinical data. Alternately, the system can use new research data to detect hitherto unsuspected risks to the individual and that individual can be notified of the impact of this information.

In another embodiment, enhanced reports can be generated for clinicians using outcome prediction models trained on data integrated from databases of genetic data, phenotypic data, and clinical records including relevant diagnostic tests. This system may provide for the creation of enhanced reports for individuals with diseases and/or disease predispositions, including but not limited to HIV, cancer, Alzheimers and heart diseases. These enhanced reports will indicate to a treating physician which disease-management or preventative treatments may be more or less suitable for a given individual. The report will include predictions and confidence bounds for key outcomes for that individual using models trained on aggregated subject data.

According to one embodiment, a system and method for making predictions regarding a specific individual that makes use of convex optimization techniques that enable continuous subset selection of independent variables to create sparse regression models, where said predictions concern topics taken from a group comprising said individual's phenotypes, phenotype susceptibilities, possible clinical outcomes, and combinations thereof is provided. In certain embodiments, the method may be non-linear using Support Vector Machine with radial basis kernel functions. In other embodiments, the method may be linear using the LASSO technique. In some examples, the method may use a norm loss function to create a sparse model that is either linear or nonlinear.

According to another embodiment, a system and method where data about a specific individual is used to make predictions about said individual using models based on contingency tables and built from information available in the public domain, where said data is taken from a group consisting of said individual's genetic data, said individual's phenotypic data, said individual's clinical data, and combinations thereof, and where said predictions concern topics taken from a group comprising said individual's phenotypes, phenotype susceptibilities, and possible clinical outcomes, and where said information is taken from a group comprising information about genotype-phenotype associations, information about the frequency of certain genetic alleles, information about the frequency of certain associations among genetic alleles, information about the probability of one or more states of certain phenotypes given certain combinations of genetic alleles, information about the probability of a certain combinations of genetic alleles given the state of a certain phenotypes, and combinations thereof is disclosed.

According to yet another embodiments, a system and method whereby data about a specific individual can be used to make predictions about said individual using a variety of mathematical models trained on aggregated data in a way that the model which shows the best accuracy can be utilized, where said individual's data is taken from a group consisting of said individual's genetic data, said individual's phenotypic data, and said individual's clinical data, and where said predictions concern topics taken from a group comprising said individual's phenotypes, phenotype susceptibilities, possible clinical outcomes, and combinations thereof is provided. In certain embodiments, the method may examine many or all of the different independent variable and dependant variable combinations in a given set of data, using multiple models and multiple tuning parameters, and then selects that combination of independent variables and dependant variables, that model and those tuning parameters that achieved the highest correlation coefficient with the test data for the purpose of making the best phenotypic predictions.

According to another embodiment, any of the methods disclosed herein may use predictions to generate reports for a specific individual concerning one or more topics that are relevant to said individual, where said topics are taken from a group comprising lifestyle decisions, dietary habits, hormonal supplements, possible treatment regimens for a disease, possible treatment regimens for a pathogen, drug interventions, and combinations thereof, and where said prediction is based on data concerning said individual's genetic makeup, said individual's phenotypic characteristics, said individual's clinical history, and combinations thereof.

According to other embodiments, any of the methods disclosed herein may use predictions to generate reports for an agent of a specific individual, such as a physician or clinician, and where said predictions could aid said agent by providing information relevant to said individual, and where the subject of said information is taken from a group of topics comprising lifestyle decisions, dietary habits, hormonal supplements, possible treatment regimens for a disease, possible treatment regimens for a pathogen, drug interventions, other therapeutic interventions, and combinations thereof, and where said prediction is based on data concerning said individual's genetic makeup, said individual's phenotypic characteristics, said individual's clinical history, and combinations thereof.

According to another embodiment, any of the methods disclosed herein may use predictions benefit a specific individual afflicted with cancer, and where said predictions could aid clinicians by providing information relevant to that individual and or to the specific cancer of said individual, and where the subject of said information is taken from a group of topics comprising treatment regimens, lifestyle decisions, and dietary habits, drug interventions, other therapeutic interventions, and combinations thereof, and where said prediction is based on data concerning said individual's genetic makeup, said individual's phenotypic characteristics, said individual's clinical history, and combinations thereof.

According to one embodiment, any of the methods disclosed herein may be used to benefit a specific individual afflicted with a pathogen, and where said predictions could aid clinicians by providing information relevant to that individual and or to the specific pathogen infecting said individual, where said pathogen is of a class taken from a group consisting of bacteria, virus, microbe, amoeba, fungus and other parasites, and where the subject of said information is taken from a group of topics comprising treatment regimens, lifestyle decisions, and dietary habits drug interventions, other therapeutic interventions, and combinations thereof, and where said prediction is based on data concerning said individual's genetic makeup, said individual's phenotypic characteristics, said individual's clinical history, and combinations thereof.

According to another embodiment, any of the methods disclosed herein may use predictions regarding a specific individual, new knowledge and data as that knowledge and data becomes available, and which could be used to generate informational reports, automatically or on-demand, regarding topics that are relevant to said individual, where the topics are taken from a group comprising lifestyle decisions, dietary habits, hormonal supplements, possible treatment regimens for a disease, possible treatment regimens for a pathogen, drug interventions, other therapeutic interventions, and combinations thereof, and where the new knowledge and data are medical in nature, and where the prediction is based on data concerning said individual's genetic makeup, said individual's phenotypic characteristics, said individual's clinical history, and combinations thereof.

According to another embodiment, any of the methods disclosed herein may use predictions using genetic data from a specific embryo and said predictions can be used to aid in selection of embryos in the context of IVF based on predicted susceptibility to certain phenotypes of said embryo.

According to one embodiment, any of the methods disclosed herein may use predictions using genetic data from a specific fetus, and said predictions can be used to estimate particular phenotypic outcomes for the potential progeny, such as life expectancy, the probability of psoriasis, or the probability of a particular level of mathematical ability.

It will be recognized by the person of ordinary skill in the art, given the benefit of this disclosure, that other aspects, features and embodiments may implement one or more of the methods and systems disclosed herein.

### BRIEF DESCRIPTION OF THE DRAWINGS

Table 1 is a summary of disease genes as found in OMIM/NCBI.

Table 2 is three contingency tables representing the results of Farrer (2005), Labert (1998), and Alvarez (1999) for understanding the role of mutations in APOE and ACE in affecting the onset of Alzheimers.

Table 3 shows results generated from meta-analysis of the studies of Table 2.

Table 4 is a table of correlation coefficients (R in %) of measured and predicted response to Protease Inhibitor (PI) drugs for various methods, averaged over ten different 9:1 splits of training and testing data. The standard deviation (Std. dev.) of the results is shown in gray; the number of measured drug responses is shown in the last row.

Table 5 is a table of correlation coefficients (R in %) of measured and predicted response to Reverse Transcriptase Inhibitor (RTI) drugs for various methods, averaged over ten different 9:1 splits of training and testing data. The standard deviation (Std. dev.) of the results is shown in gray; the number of measured drug responses is shown in the last row.

Table 6 shows the number of samples, and total number of mutations used for training for various regression methods, together with the number of mutations with non-zero weights selected by the Least Absolute Selection and Shrinkage Operator (LASSO) as predictors for Protease Inhibitor (PI) drug response.

Table 7 shows the number of samples, and total number of mutations used for training with various methods, together with the number of mutations with non-zero weights selected by LASSO as predictors for Reverse Transcriptase Inhibitor (RTI) response.

Table 8 shows phenotypic data for the irinotecan study.

FIG. 1 is an illustration of the LASSO tendency to produce sparse solutions. The Ridge regression solution lies at the meeting of the two circles, and the LASSO solution lies at the meeting of the circle and square.

FIG. 2 is a table of the correlation coefficients (R in %) of measured and predicted response, averaged over ten different 9:1 splits of training and testing data, and then averaged over seven PIs or ten RTIs respectively.

FIG. 3 graphically represents the value of LASSO model parameters associated with mutations in the protease enzyme for predicting PI response. Only 40 parameters with the largest absolute magnitudes are shown.

FIG. 4 graphically represents the value of LASSO model parameters associated with mutations in the RT enzyme for predicting NRTI drug response. Only the 40 parameters with the largest absolute magnitudes are shown.

FIG. 5 graphically represents the value of LASSO model parameters associated with mutations in the RT enzyme for predicting NNRTI drug response. Only the 40 parameters with the largest absolute magnitudes are shown.

FIG. 6 is a flow chart describing the system which allows the optimal method to be chosen for the purpose of making the best phenotypic predictions given a set of data.

FIG. 7 shows prediction of absolute neutrophil count, given SNPs of gene UGT1A1 and irinotecan metabolite measures.

FIG. 8 is a graphic illustrating integration of patient data into computable format, analysis of data using the disclosed system and method, and generation of an enhanced report.

FIG. 9 is a mock personalized report for colon cancer.

### DETAILED DESCRIPTION

The following information is provided to facilitate a better understanding of the technology.

As the amount of data available has become enormous, and is still increasing rapidly, the crux of the problem has become designing and implementing good methods that allow the most appropriate correlations to be uncovered and used to benefit people. As the number of variables available to analyze has increased, it has become more important to develop methods that are able to digest the astronomical number of potential correlations, and do not a-priori rule any of them out. At the same time it is important to develop methods that can integrate and utilize the findings of multiple studies, even when those studies were not conducted with identical protocols. It is also becoming increasingly important, given the large number of prediction models which have been studied, to develop systems that can correctly identify the optimal method to use in a given analysis.

Much research has been done in predictive genomics, which tries to understand the precise functions of proteins, RNA and DNA so that phenotypic predictions can be made based on genotype. Canonical techniques focus on the function of Single-Nucleotide Polymorphisms (SNP); but more advanced methods are being brought to bear on multi-factorial phenotypic features. These methods include techniques, such as linear regression and nonlinear neural networks, which attempt to determine a mathematical relationship between a set of genetic and phenotypic predictors and a set of measured outcomes. There is also a set of regression analysis techniques, such as Ridge regression, log regression and stepwise selection, that are designed to accommodate sparse data sets where there are many potential predictors relative to the number of outcomes, as is typical of genetic data, and which apply additional constraints on the regression parameters so that a meaningful set of parameters can be resolved even when the data is underdetermined. Other techniques apply principal component analysis to extract information from undetermined data sets. Other techniques, such as decision trees and contingency tables, use strategies for subdividing subjects based on their independent variables in order to place subjects in categories or bins for which the phenotypic outcomes are similar. A recent technique, termed logical regression, describes a method to search for different logical interrelationships between categorical independent variables in order to model a variable that depends on interactions between multiple independent variables related to genetic data.

In U.S. Pat. No. 5,824,467 Mascarenhas describes a method to predict drug responsiveness by establishing a biochemical profile for patients and measuring responsiveness in members of the test cohort, and then individually testing the parameters of the patients' biochemical profile to find correlations with the measures of drug responsiveness. In U.S. Pat. No. 7,058,616 Larder et al. describe a method for using a neural network to predict the resistance of a disease to a therapeutic agent. In U.S. Pat. No. 6,958,211 Vingerhoets et al. describe a method wherein the integrase genotype of a given HIV strain is simply compared to a known database of HIV integrase genotype with associated phenotypes to find a matching genotype. In U.S. Pat. 7,058,517 Denton et al. describe a method wherein an individual's haplotypes are compared to a known database of haplotypes in the general population to predict clinical response to a treatment. In U.S. Pat. 7,035,739 Schadt at al. describe a method is described wherein a genetic marker map is constructed and the individual genes and traits are analyzed to give a gene-trait locus data, which are then clustered as a way to identify genetically interacting pathways, which are validated using multivariate analysis. In U.S. Pat. No. 6,025,128 Veltri et al. describe a method involving the use of a neural network utilizing a collection of biomarkers as parameters to evaluate risk of prostate cancer recurrence. In U.S. Pat. No. 6,489,135 Parrott et al. provide methods for determining various biological characteristics of in vitro fertilized embryos, including overall embryo health, implantability, and increased likelihood of developing successfully to term by analyzing media specimens of in vitro fertilization cultures for levels of bioactive lipids in order to determine these characteristics. In U.S. Patent Application 20040033596 Threadgill et al. describe a method for preparing homozygous cellular libraries useful for in vitro phenotyping and gene mapping involving site-specific mitotic recombination in a plurality of isolated parent cells. In U.S. Pat. No. 5,994,148 Stewart et al. describe a method of determining the probability of an in vitro fertilization (IVF) being successful by measuring Relaxin directly in the serum or indirectly by culturing granulosa lutein cells extracted from the patient as part of an IVF/ET procedure. In U.S. Pat. No. 5,635,366 Cooke et al. provide a method for predicting the outcome of IVF by determining the level of 11.beta.-hydroxysteroid dehydrogenase (11.beta.-HSD) in a biological sample from a female patient.

None of the currently available methods provide an effective and efficient means of extracting the most simple and intelligible rules from the data by exploring a wide array of terms that are designed to model the effect of variables related to genetic data. More specifically, most or all of the currently available methods have the following drawbacks: (i) they do not use convex optimization techniques and thus are not guaranteed to find the local minimum solution for the model parameters for a given training data set; (ii) they do not use techniques that minimize the complexity of the model and thus they do not build models that generalize well when there are a small number of outcomes relative to the number of independent variables; (iii) they do not enable the extraction of the most simple intelligible rules from the data in the context of logistic regression without making the simplifying assumption of normally distributed data; (iv) they do not leverage a-priori information about gene-gene associations, gene-phenotype associations, and gene-disease associations in order to make the best possible prediction of phenotype or phenotype susceptibility; (v) they do not provide more than one model, and thus do not provide a general approach for selecting the best possible data based on cross-validating various models against training data. These shortcomings are critical in the context of predicting outcomes based on the analysis of vast amounts of data classes relating to genetic and phenotypic information. In summary the currently available methods do not effectively empower individuals to ask questions about the likelihood of particular phenotypic features given genotype, or about the likelihood of particular phenotypic features in an offspring given the genotypic features of the parents.

Bioinformatics in the Context of HIV

HIV is considered pandemic in humans with more than 30 million people currently living with HIV, and more than 2 million deaths each year attributable to HIV. One of the major characteristics of HIV is its high genetic variability as a result of its fast replication cycle and the high error rate and recombinogenic properties of reverse transcriptase. As a result, various strains of the HIV virus show differing levels of resistance to different drugs, and an optimal treatment regimen may take into account the identity of the infective strain and its particular susceptibilities.

As of today, approved ART drugs consist of a list of eleven RTIs: seven nucleoside, one nucleotide and three non-nucleoside; seven PIs; and one fusion/entry inhibitor. Given the current rollout of ART drugs around the world the appearance of resistance strains of the virus is inevitable, both due to the low genetic barrier to resistance and to poor drug adherence. Consequently, techniques to predict how mutated viruses will respond to anti-retroviral therapy are increasingly important as they will influence the outcome for salvage therapies. The rapidly decreasing cost of viral genetic sequencing—with volume pricing as low as $5 for pre-prepared sequences—makes the selection of drugs based on viral genetic sequence data an attractive option, rather than the more costly and involved in-vitro phenotype measurement. The use of sequence data, however, necessitates accurate predictions of viral drug response, based on the appearance of viral genetic mutations. The many different combinations of viral mutations make it difficult to design a model that includes all the genetic cofactors and their interactions, and to train the model with limited data. The latter problem is exacerbated in the context of modeling in-vivo drug response, where the many different combinations of drug regimens make it difficult to collect sufficiently large data sets for any particular regimen that contain the variables, namely baseline clinical status, treatment history, clinical outcome and genetic sequence.

Resistance to antiviral drugs can be the result of one mutation within the RT or protease sequences, or the combination of multiple mutations. The RT enzyme is coded by a key set of 560 codons; the protease enzyme by 99 codons. By considering only mutations that alter the amino acids, each amino acid locus has 19 possible mutations; so there are a total of 10,640 possible mutations that differ from wild type on the RT enzyme, and 1,981 possible mutations on the protease enzyme. Using a simple linear model, where each mutation encountered in the data (not all mutations will occur) is associated with a particular weighting, or linear regression parameter, several thousand parameters may exist. If only several hundred patient samples are available for each drug, the problem is overcomplete, or ill-posed in the Hadamard sense, since there are more parameters to estimate than independent equations. Many techniques exist that can be applied to the problem of constructing models for the ill-posed problem. These include combining a-priori expert knowledge with observations to create expert-rule based systems, as well as statistical methods including i) ridge regression, ii) principal component analysis, iii) decision trees, iv) stepwise selection techniques, v) Neural Networks, vi) the Least Absolute Shrinkage and Selection Operator (LASSO), and vii) Support Vector Machines (SVM).

Three main industry-standard expert systems are typically used to predict the susceptibility of HIV viruses to ART drugs: the ANRS-AC11 System, the Rega System, and the Stanford HIVdb system. It is commonplace in the literature for new algorithms to be benchmarked against these expert systems. None of these expert systems, however, is designed to perform direct prediction of phenotypic response, but rather to provide a numeric score by which different drugs can be compared, or to classify the drugs into discrete groupings such as Sensitive, Intermediate and Resistant. In addition, it has been clearly established that statistical algorithms, such as linear regression models trained with stepwise selection, substantially outperform expert systems in prediction of phenotypic outcome. Consequently, only a set of statistical techniques is compared, which includes the best performing methods recently disclosed in the literature.

Current approaches to predicting clinical outcomes of salvage ART do not demonstrate good predictive power, largely due to a lack of statistically significant outcome data, combined with the many different permutations of drug regimens and genetic mutations. This field has a pressing need both for the integration of multiple heterogeneous data sets and the enhancement of drug response prediction.

Bioinformatics in the Context of Cancer

Of the estimated 80,000 annual clinical trials, 2,100 are for cancer drugs. Balancing the risks and benefits for cancer therapy represents a clinical vanguard for the combined use of phenotypic and genotypic information. Although there have been great advances in chemotherapy in the past few decades, oncologists still treat their cancer patients with primitive systemic drugs that are frequently as toxic to normal cells as to cancer cells. Thus, there is a fine line between the maximum toxic dose of chemo and the therapeutic dose. Moreover, dose-limiting toxicity may be more severe in some patients than others, shifting the therapeutic window higher or lower. For example, anthracyclines used for breast cancer treatment can cause adverse cardiovascular events. Currently, all patients are treated as though at risk for cardiovascular toxicity, though if a patient could be determined to be at low-risk for heart disease, the therapeutic window could be shifted to allow for a greater dose of anthracycline therapy.

To balance the benefits and risks of chemotherapy for each patient, one may predict the side effect profile and therapeutic effectiveness of pharmaceutical interventions. Cancer therapy often fails due to inadequate adjustment for unique host and tumor genotypes. Rarely does a single polymorphism cause significant variation in drug response; rather, manifold polymorphisms result in unique biomolecular compositions, making clinical outcome prediction difficult. “Pharmacogenetics” is broadly defined as the way in which genetic variations affect patient response to drugs. For example, natural variations in liver enzymes affect drug metabolism. The future of cancer chemotherapy is targeted pharmaceuticals, which require understanding cancer as a disease process encompassing multiple genetic, molecular, cellular, and biochemical abnormalities. With the advent of enzyme-specific drugs, care may be taken to insure that tumors express the molecular target specifically or at higher levels than normal tissues. Interactions between tumor cells and healthy cells may be considered, as a patient's normal cells and enzymes may limit exposure of the tumor drugs or make adverse events more likely.

Bioinformatics will revolutionize cancer treatment, allowing for tailored treatment to maximize benefits and minimize adverse events. Functional markers used to predict response may be analyzed by computer algorithms. Breast, colon, lung and prostate cancer are the four most common cancers. An example of two treatments for these cancers are tamoxifen, which is used to treat breast cancer, and irinotecan which is used in colon cancer patients. Neither tamoxifen or irinotecan are necessary or sufficient for treating breast or colon cancer, respectively. Cancer and cancer treatment are dynamic processes that require therapy revision, and frequently combination therapy, according to a patient's side effect profile and tumor response. If one imagines cancer treatment as a decision tree, to give or withhold any one treatment before, after, or with other therapies, then this tree comprises a subset of decision nodes, where much of the tree (i.e. other treatments) can be considered a black box. Nonetheless, having data to partially guide a physician to the most effective treatment is advantageous, and as more data is gathered, an effective method for making treatment decisions based on this data could significantly improve life expectancies and quality of living in thousands of cancer patients.

Colon Cancer

The colon, or large intestine, is the terminal 6-foot section of the gastrointestinal (GI) tract. The American Cancer Society estimates that 145,000 cases of colorectal cancer will be diagnosed in 2005, and 56,000 will die as a result. Colorectal cancers are assessed for grade, or cellular abnormalities, and stage, which is subcategorized into tumor size, lymph node involvement, and presence or absence of distant metastases. 95% of colorectal cancers are adenocarcinomas that develop from genetically-mutant epithelial cells lining the lumen of the colon. In 80-90% of cases, surgery alone is the standard of care, but the presence of metastases calls for chemotherapy. One of many first-line treatments for metastatic colorectal cancer is a regimen of 5-fluorouracil, leucovorin, and irinotecan.

Irinotecan is a camptothecin analogue that inhibits topoisomerase, which untangles super-coiled DNA to allow DNA replication to proceed in mitotic cells, and sensitizes cells to apoptosis. Irinotecan does not have a defined role in a biological pathway, so clinical outcomes are difficult to predict. Dose-limiting toxicity includes severe (Grade III-IV) diarrhea and myelosuppression, both of which require immediate medical attention. Irinotecan is metabolized by uridine diphosphate glucuronosyl-transferase isoform 1a1 (UGT1A1) to an active metabolite, SN-38. Polymorphisms in UGT1A1 are correlated with severity of GI and bone marrow side effects.

Prenatal and Pre-Implantation Genetic Diagnosis

Current methods of prenatal diagnosis can alert physicians and parents to abnormalities in growing fetuses. Without prenatal diagnosis, one in 50 babies is born with serious physical or mental handicap, and as many as one in 30 will have some form of congenital malformation. These methods include amniocentesis, chorion villus biopsy and fetal blood sampling. The amniocentesis rate was 1.7 percent of all live births in 2003, down from 1.9 percent in 2002 and 3.2 percent in 1989. In the near future, it is expected that these methods may also include non-invasive prenatal diagnosis based on fetal genetic material isolated from maternal blood.

Much research has gone into the use of pre-implantation genetic diagnosis (PGD) as an alternative to classical prenatal diagnosis of inherited disease. Most PGD today focuses on high-level chromosomal abnormalities such as aneuploidy and balanced translocations with the primary outcomes being successful implantation and a take-home baby. Current methods exist which have the capability to measure SNPs. These include. PCR-based whole genome amplification (WGA) techniques such as multiple displacement amplification (MDA), Molecular Inversion Probe (MIPS) and non-PCR based techniques such as fluorescence in situ hybridization (FISH). These amplify the DNA from a single cell (blastomere), a small number of cells, or from a smaller collection of chromosomes or fragments of DNA, followed by microrray genotyping analysis. Note that these techniques described are relevant both to single-cell measurements, as well as to measurements on smaller amounts of DNA such as that which can be isolated from the mother's blood in the context of Non-invasive Prenatal Diagnosis (NIPD).

In both prenatal and pre-implantation genetic diagnosis the goal is to make phenotypic predictions about the genome in question. With the number of known disease associated genetic alleles currently at 389 according to OMIM and steadily climbing, it will become increasingly relevant to analyze multiple embryonic SNPs that are associated with disease phenotypes. In addition, as understanding of the genome increases, prediction of multi-factorial complex phenotypes will be increasingly relevant, and the development of methods that can accomplish this will be desirable.

Current Sources of Integrated, Standardized Data

Modern medical research works under the paradigm of first using local sets of data to identify correlations between phenotypic, genotypic and clinical differences in relevant patient populations, and then disseminating those correlations for the benefit of the community. Widespread meta-analysis of data has been hampered by the analog nature of some published data, the inhomogenaiety of databases, and the inaccessibility of those databases. As more data becomes available on-line, it will be possible to perform more complex meta-analyses considering far more variables and sources of data than before.

Numerous current products and research efforts focus on integrating clinical and genomic data from disparate sources. These include centralized database projects exemplified by Genbank, the FMRI Data Center and the Protein Data Bank, laboratory-specific internet tools like the Flytrap interactive database, distributed data collaboration networks such as BIRN, commercial tools for data organization like Axiope, and large database systems for aggregating healthcare information such as Oracle HTB. The most successful approaches make use of a standardized master ontology that provides a framework to organize input data, as well as a technology scheme for augmenting and updating the existing ontology. This paradigm has been successfully applied in the Gene Ontology (GO), Mouse Gene Database (MGD), and the Mouse Gene Expression Database (GXD) projects, which provide a taxonomy of concepts and their attributes for annotating gene products.

A number of tools have been developed to manage the integration of existing data sets. For example, success has been achieved with tools that input textual data and generate standardized terminology in order to achieve information integration such as, for example, the Unified Medical Language System. (UMLS): Integration Biomedical Terminology. Tools have been developed to inhale data into new ontologies from specific legacy systems, using object definitions and Extensible Markup Language (XML) to interface between the data model and the data source, and to validate the integrity of the data inhaled into the new data model. Bayesian classification schemes such as MAGIC (Multisource Association of Genes by Integration of Clusters) have been created to integrate information from multiple sources into a single normative framework, using expert knowledge about the reliability of each source. Several commercial enterprises are also working on techniques to leverage information across different platforms. For example, Expert Health Data Programming provides the Vitalnet software for linking and disseminating health data sets; CCS Informatics provides the eLoader software which automates loading data into Oracle® Clinical; PPD Patient Profiles enables visualization of key patient data from clinical trials; and TableTrans® enables specification of data transformations graphically.

Products exist to manage information in support of caregivers and for streamlining clinical trials. Some of the enterprises involved in this space include Clinsource which specializes in software for electronic data capture, web randomization and online data management in clinical trials; Perceptive Informatics which specializes in electronic data capture systems, voice response systems, and web portal technologies for managing the back end information flow for a trial; and First Genetic Trust which has created a genetic bank that enables medical researchers to generate and manage genetic and medical information, and that enables patients to manage the privacy and confidentiality of their genetic information while participating in genetic research. None of these systems make use of expert and statistical relationships between data classes in a standardized data model in order to validate data or make predictions; or provide a mechanism by which electronically published rules and statistical models can be automatically input for validating data or making predictions; or guarantee strict compliance with data privacy standards by verifying the identity of the person accessing the data with biometric authentication; or associate all clinical data with a validator the performance of which is monitored so that the reliability of data from each independent source can be efficiently monitored; or allow for compensation of individuals for the use of their data; or allow for compensation of validators for the validation of that data.

Conceptual Overview of the System

One may consider genotype-phenotype predictive models in three categories: i) genetic defects or alleles are known to cause the disease phenotype with 100% certainty; ii) genetic defects and alleles that increase the probability of disease phenotype, where the number of predictors is small enough that the phenotype probability can be modeled with a contingency table; and iii) complex combinations of genetic markers that can be used to predict phenotype using multidimensional linear or nonlinear regression models. Of the 359 genes (See Table 1, row 2) with currently known sequences and disease phenotypes in the Online Mendelian Inheritance Database (OMIM), the majority fall into category (i); and the remainder fall predominantly into category (ii). However, over time, it is expected that multiple genotype-phenotype models will arise in category (iii), where the interaction of multiple alleles or mutations will need to be modeled in order to estimate the probability of a particular phenotype. For example, scenario (iii) is certainly the case today in the context of predicting the response of HIV viruses to anti-retroviral therapy based on the genetic data of the HIV virus.

For scenario (i), it is usually straightforward to predict the occurrence of the phenotype based on expert rules. In one aspect, statistical techniques are described that can be used to make accurate predictions of phenotype for scenarios (ii). In another aspect, statistical techniques are described that can be used to make accurate predictions for scenario (iii). In another aspect, methods are described by which the best model can be selected for a particular phenotype, a particular set of aggregated data, and a particular individual's data.

Certain embodiments of the methods disclosed herein implement contingency tables to accurately make predictions in scenario (ii). These techniques leverage a-priori information about gene-gene associations and gene-disease associations in order to improve the prediction of phenotype or phenotype susceptibility. These techniques enable one to leverage data from previous studies in which not all the relevant independent variables were sampled. Instead of discarding these previous results because they have missing data, the technique leverages data from the HapMap project and elsewhere to make use of the previous studies in which only a subset of the relevant independent variables were measured. In this way, a predictive model can be trained based on all the aggregated data, rather than simply that aggregated data from subjects for which all the relevant independent variables were measured.

Certain embodiments of the methods described herein use convex optimization to create sparse models that can be used to make accurate predictions in scenario (iii). Genotype-phenotype modeling problems are often overcomplete, or ill-posed, since the number of potential predictors—genes, proteins, mutations and their interactions—is large relative to the number of measured outcomes. Such data sets can still be used to train sparse parameter models that generalize accurately, by exerting a principle similar to Occam's Razor: When many possible theories can explain the observations, the most simple is most likely to be correct. This philosophy is embodied in one aspect relating to building genotype-phenotype models in scenario (iii) discussed above. The techniques described here for application to genetic data involve generating sparse parameter models for underdetermined or ill-conditioned genotype-phenotype data sets. The selection of a sparse parameter set exerts a principle similar to Occam's Razor and consequently enables accurate models to be developed even when the number of potential predictors is large relative to the number of measured outcomes. In addition, certain embodiments of the techniques described here for building genotype-phenotype models in scenario (iii) use convex optimization techniques which are guaranteed to find the global minimum solution for the model parameters for a given training data set.

Given a set of aggregated data, and a set of available data for an individual, it is seldom clear which prediction approach is most appropriate for making the best phenotypic prediction for that individual. In addition to describing a set of methods that tend to make accurate phenotypic predictions, embodiments disclosed herein present a system that tests multiple methods and selects the optimal method for a given phenotypic prediction, a given set of aggregated data, and a given set of available data for the individual for whom the prediction is to be made. The disclosed methods and systems examine all the different independent variable and dependant variable combinations in a given set of data using multiple models and multiple tuning parameters, and then selects that combination of independent variables, dependant variables, and those tuning parameters that achieve the best modeling accuracy as measured with test data. In cases corresponding to scenario (i) expert rules may be drawn; in other cases with few independent variables, such as in category (ii), contingency tables will provide the best phenotype prediction; and in other cases such as scenario (iii) linear or non-linear regression techniques may be used to provide the optimal method of prediction. Note that it will be clear to one skilled in the art, after reading this disclosure, how the approach to selecting the best model to make a prediction for an individual may be used to select from amongst many modeling techniques beyond those disclosed here.

Certain embodiments of the technology are demonstrated in several contexts. First, it is demonstrated in the context of predicting the likelihood of developing Alzheimer's disease using contingency tables and an incomplete set of data integrated from many clinical studies focusing on predicting Alzheimer's disease based on genetic markers. Next, the system is demonstrated in the context of modeling the drug response of Type-1 Human Immunodeficiency Virus (HIV-1) using regression analysis and the knowledge of genetic markers in the viral genome. Finally the system is demonstrated in the context of predicting the side-effects caused by the usage of tamoxifen and irinotecan in the treatment of various cases of breast and colon cancer, respectively, using regression analysis and the incomplete data of both genetic markers on the individuals and also laboratory and clinical subject information relevant to the cancer.

Due to the decreasing expense of genotypic testing, statistical models that reliably predicts viral drug response, cancer drug response, and other phenotypic responses or outcomes from genetic data are important tools in the selection of appropriate courses of action whether they be disease treatments, lifestyle or habit decisions, or other actions. The optimization techniques described will have application to many genotype-phenotype modeling problems for the purpose of enhancing clinical decisions.

Technical Description of the System

There are many models available for predicting phenotypic data from genotypic and clinical information. Different models are more appropriate in different situations, based on the amount and type of data available. In order to choose the most appropriate method for phenotype prediction, it is often best to test multiple methods on a set of testing data, and determine which method provides the best accuracy of predictions when compared to the measured outcomes of the test data. Certain embodiments described herein include a set of methods which, when taken in combination and selected based on performance with test data, will provide a high likelihood of making accurate phenotypic predictions. First, a technique for genotype-phenotype modeling in scenario (ii) using contingency tables is described. Next, a technique for genotype-phenotype modeling in scenario (iii) using regression models built by convex optimization is described. Then, a technique for choosing the best model given a particular phenotype to be predicted, a particular patient's data, and a particular set of data for training and testing a model is described.

The Data of Today: Modeling Phenotypic Outcomes based on Contingency Tables

In cases where there are known genetic defects and alleles that increase the probability of disease phenotype, and where the number of predictors is sufficiently small, the phenotype probability can be modeled with a contingency table. If there is only one relevant genetic allele, the presence/absence of a particular allele can be described as A+/A− and the presence absence of a disease phenotype as D+/D−. The contingency table containing (f₁, N₁, f₂, N₂) is:

${S}^{2} = \frac{{N}_{1} {N}_{2} ( {N}_{1} + {N}_{2} ) {( {p}_{1} ( 1 - {p}_{2} ) - ( 1 - {p}_{1} ) {p}_{2} )}^{2}}{( {p}_{1} {N}_{1} + {p}_{2} {N}_{2} ) ( ( 1 - {p}_{1} ) {N}_{1} + ( 1 - {p}_{2} ) {N}_{2} )}$

| | D+ | D− | # |
|---|---|---|---|
| G+ | f₁ | 1-f₁ | N₁ |
| G− | f₂ | 1-f₂ | N₂ |

Where f₁ and f₂ represent the measured frequencies or probabilities of different outcomes and the total number of subjects is N=N₁+N₂. From this table, the odds ratio for the probability of having disease state D+ in the two cases of having independent variable (IV) G+ or G− can be reported as OR=f₁(1−f₂)/f₂(1−f₁) with a with 95% confidence interval: OR^{1±1.96/S}, where S is a standard deviation. For example, using a study of breast cancer in 10,000 individuals, where M+ represents the presence of BRCA1 or BRCA2 allele:

| | D+ | D− | # |
|---|---|---|---|
| M+ | .563 | .437 | 1720 |
| M− | .468 | .532 | 8280 |

This data results in an odds ratio, OR=1.463, with confidence interval [1.31;1.62], which can be used to predict the increased probability of the occurrence of breast cancer with the given mutation. Note that contingency tables greater than two by two can be used to accommodate more independent variables or outcome variables. For example, in the case of breast cancer, the contingencies M+ and M− could be replaced with the four contingencies: BRCA1 and BRCA2, BRCA1 and not BRCA2, not BRCA1 and BRCA2, and finally not BRCA1 and not BRCA2. It is well understood by those knowledgeable in the art how to determine confidence intervals for contingency tables greater than two by two. This technique will be used when there are few enough IVs and enough data to build models with low standard deviations by counting the patients in different groups defined by different contingencies of the independent variables. This approach avoids the difficulty of designing a mathematical model that relates the different IV's to the outcome that is to be modeled, as is needed when constructing a regression model.

Note that the genetic data from particular SNPs may also be projected onto other spaces of independent variables, such as in particular the different patterns of SNPs that are recognized in the HapMap project. The HapMap project clusters individuals into bins, and each bin will be characterized by a particular pattern of SNPs. For example, consider one bin (B1) has a SNP pattern that contains BRCA1 and BRCA2, another bin (B2) has a SNP pattern that contains BRCA1 and not BRCA2, and a third bin contains a SNP pattern (B3) that is associated all other combinations of mutations. Rather than creating a contingency table representing all the different combinations of these SNPS, one may create a contingency table representing the contingencies B1, B2, and B3.

Note furthermore that the tendency of certain SNPs to occur together, as described by the HapMap project, can be used to create models that use multiple SNPs as predictors, even then the data consists of separate groups of patients where each group has had only one of the SNPs measured. This problem is commonly encountered when creating models from publicly available research papers, such as those available from OMIM, where each paper contains data on a cohort that has only one relevant SNP measured, although multiple SNPs are predictive of the phenotype. In order to illustrate this aspect which is useful for building predictive models using data available today, specific reference is made to Alzheimer's disease for which predictive models can be built based on the IVs: family history of Alzheimer's, gender, race, age, and the various alleles of three genes, namely APOE, NOS3, and ACE. In the context of this disease, a pervasive issue that applies to many diseases beyond Alzheimers is discussed: although many genes are involved in determining propensity for a particular phenotype, the vast majority of historical studies only sampled the alleles of a particular gene. In the case of Alzheimers disease, almost all study cohorts have only one gene sampled, namely APOE, NOS3, or ACE. Nonetheless, it is important to build models that input multiple genetic alleles even when the majority of available data comes from studies where only one gene is investigated. This problem is addressed in one aspect which is illustrated by considering a simplified case of two phenotype states and only two independent variables representing two relevant genes, each with just two states. Given a random variable describing the disease phenotype Dε[D+,D−], and two random variables describing the genes Aε[A+, A−] and Bε[B+, B] the goal is to find the best possible estimate of P(D/A,B). This can be found by applying Bayes Rule using P(D/A,B)=P(A,B/D)P(D)/P(A,B). P(D) and P(A,B) are available from public data. Specifically, P(D) refers to the overall prevalence of the disease in the population and this can be found from publicly available statistics. In addition, P(A,B) refers to the prevalence of particular states of the genes A and B occurring together in an individual and this can be found from public databases such as the HapMap Project which has measured many different SNPs on multiple individuals in different racial groups. Note that in a preferred embodiment, all of these probabilities will be computed for particular racial groups and particular genders, for which there are probability biases, rather than for the whole human population. Once these probabilities have been determined, the challenge comes from accurately estimating P(A,B/D) since the majority of cohort data provides estimates of P(A/D) and P(B/D). Relevant information can be found in various public databases, such as the HapMap Project, about the statistical associations between different genetic alleles i.e. about P(A/B). However, given only P(A/B), P(A/D), P(B/D) still nothing can be said of P(A,B/D) since there is an unconstrained degree of freedom. Nonetheless, if some information is known about P(A,B/D) from a cohort for which both genes A and B were sampled, even for just a single contingency such as (A−,B−) then the wealth of information about P(A/D), P(B/D), P(A/B) may be leveraged to improve estimates of P(A,B/D). This concept will be illustrated using contingency tables.

Consider the two contingency tables below, representing the probabilities of outcomes D+ and D− subject to the genetic states A+ and A−. This study is referred to as A. The measured frequencies for A are referred to with f and the actual probabilities that one seeks to estimate are referred to with p.

| A | D+ | D− |
|---|---|---|
| A+ | f₁ | f₂ |
| A− | f₃ | f₄ |
| A+ | p₁ | p₂ |
| A− | p₃ | p₄ |

where f₃=1−f₁, f₄=1−f₂ and p₃=1−p₁, p₄=1−p₂. Let K₁ represent the number of subjects in the case group for A, that is, the number of subjects that have outcome D+. Let K₂ be the number in the control group for A, that is, the number of subjects that have outcome D−.

Similarly, consider the two contingency tables below, representing the probabilities of outcomes D+ and D− subject to the genetic states B+ and B−. This study is referred to as B. The measured frequencies are referred to with f and the actual probabilities that one seeks to estimate are referred to with p.

| B | D+ | D− |
|---|---|---|
| B+ | f₅ | F₆ |
| B− | f₇ | F₈ |
| B+ | P₅ | p₆ |
| B− | P₇ | p₈ |

where f₇=1−f₅, f₈=1−f₆ and p₇=1−p₅, p₈=1−p₆. Let K₃ represent the number in the case group for B and let K₄ be the number in the control group for B. The contingency tables above represent trials where the genetic states A and B are measured separately. However, the contingency table that is ideally sought out involves the different states of A and B combined. The contingency table is shown below for a hypothetical study, referred to as AB, where f represents the measured probabilities and p represents the actual probabilities.

| AB | D+ | D− |
|---|---|---|
| A+B+ | f₉ | f₁₀ |
| A+B− | f₁₁ | f₁₂ |
| A−B+ | f₁₃ | f₁₄ |
| A−B− | f₁₅ | f₁₆ |
| A+B+ | p₉ | p₁₀ |
| A+B− | p₁₁ | p₁₂ |
| A−B+ | p₁₃ | p₁₄ |
| A−B− | p₁₅ | p₁₆ |

where f₁₅=1−f₉−f₁₁−f₁₃, f₁₆=1−f₁₀−f₁₂−f₁₄ and p₁₅=1−p₉−p₁₁−p₁₃, p₁₆=1−p₁₀−p₁₂−p₁₄ Let K₅ be the number in case group for AB and let K₆ be the number in control group for AB. For notational purposes, note that K₇=K₉=K₅ and K₈=K₁₀=K₆. So in fact, group sizes are:

| # | D+ | D− |
|---|---|---|
| A | K₁ | K₂ |
| B | K₃ | K₄ |
| AB | K₅ | K₆ |

Basic rules of statistics may be used to enforce dependencies between the cells of the hypothetical contingency table AB. In this example, for cells corresponding to D+, the following relationships may be enforced:
P(A+B−/D+)=P(A+/D+)−P(A+B+/D+)
P(A−B+/D+)=P(B+/D+)−P(A+B+/D+)
P(A−B−/D+)=1−P(A+/D+)−P(B+/D+)+P(A+B+/D+)

And similarly for cells corresponding to D−:
P(A+B−/D−)=P(A+/D−)−P(A+B+/D−)
P(A−B+/D−)=P(B+/D−)−P(A+B+/D−)
P(A−B−/D−)=1−P(A+/D−)−P(B+/D−)+P(A+B+/D−)

Using the notation in the contingency tables above, and leaving out the superfluous last relationship, these relationships translate to:
p₁₁=p₁−p₉
p₁₃=p₅−p₉
p₁₂=p₂−p₁₀
p₁₄=p₆−p₁₀
or equivalently
p₁=p₉+p₁₁
p₂=p₁₀+p₁₂
p₅=p₉+p₁₃
p₆=p₁₀+p₁₄

To summarize all the relationships, below is the table of all the dependencies of p₁, . . . , p₁₆ on p₉, . . . ,p₁₆. To get a dependency between the values, the probability within the row is the summation of probabilities within the column that has value=1, for example the first row gives p₁=p₉+p₁₁.

| | p₉ | p₁₀ | p₁₁ | p₁₂ | p₁₃ | p₁₄ | p₁₅ | P₁₆ |
|---|---|---|---|---|---|---|---|---|
| p₁ | 1 | | 1 | | | | | |
| p₂ | | 1 | | 1 | | | | |
| p₃ | | | | | 1 | | 1 | |
| p₄ | | | | | | 1 | | 1 |
| p₅ | 1 | | | | 1 | | | |
| p₆ | | 1 | | | | 1 | | |
| p₇ | | | 1 | | | | 1 | |
| p₈ | | | | 1 | | | | 1 |
| p₉ | 1 | | | | | | | |
| p₁₀ | | 1 | | | | | | |
| p₁₁ | | | 1 | | | | | |
| p₁₂ | | | | 1 | | | | |
| p₁₃ | | | | | 1 | | | |
| p₁₄ | | | | | | 1 | | |
| p₁₅ | | | | | | | 1 | |
| p₁₆ | | | | | | | | 1 |

From the relationship between the frequencies and probabilities, the measurement equations fᵢ=pᵢ+nᵢ for n=9 . . . 16 may be created, where nᵢ is a noise term representing the imperfect measurement of the probability pᵢ based on frequency of occurrence fᵢ. Applying this to the relationships described above, and assuming that all the cells of contingency table AB have been measured (this is just for illustrative purposes and will be discussed below), these 10 observations may be represented:

These measurement equations may be presented in matrix notation as:
F=XP+N
Where F=[F₁, . . . , F₁₆]^{T}, P=[p₉, . . . , p₁₆]^{T} and N=[n₉, . . . , n₁₆]^{T} and X is the matrix represented in the table above. This matrix equation may be used to solve for the 8 unknown coefficients, p₉ . . . p₁₆. In this particular case we are solving for all the parameters p₉ . . . p₁₆. If we do not have all the measurements for combined A,B genes, we need at least one measurement for D+ and one for D−. Given the relationships above, we can then fill out the rest of the table. In other words, in order to be able to fill out the contingency table for the hypothetical study AB, there desirably is at least one sample where a particular state of A and B were simultaneously measured on subjects that had outcomes of both D+ and D−. This enables one to achieve full rank for the matrix X representing the measurements made, so that the values p₉ . . . p₁₆ are solved and filled in the contingency table AB. If more study data exists, further rows may be added to the bottom of the matrix X with a similar structure to that shown above.

To perform an accurate regression, a weighted regression with weights for each observation fᵢ determined by the size of the group sample is desirable, so that studies and cells with many more observations get more weight. For the measurement equations fᵢ=pᵢ+nᵢ, the nᵢ do not all have the same variance, and the regression is not homoscedastic. Specifically, fᵢ=1/Kᵢ*Binomial(pᵢ, Kᵢ)˜N(pᵢ, pᵢ(1−pᵢ)/Kᵢ) where Binomial(pᵢ, Kᵢ) represents a binomial distribution where each test has probability of the case outcome pᵢ and Kᵢ tests are performed. This binomial distribution can be approximated by N(pᵢ, pᵢ(1−pᵢ)/Kᵢ) which is the normal distribution with mean pᵢ and variance pᵢ(1−pᵢ)/Kᵢ. Consequently, the noise may be modeled as a normal variable nᵢ˜N(0, pᵢ(1−pᵢ)/Kᵢ) which has theoretical variance Vᵢ=pᵢ*(1−pᵢ)/Kᵢ. This variance can be approximated with the sample frequency vᵢ=fᵢ*(1−fᵢ)/Kᵢ.

A weighted regression with weights for each observation i inversely proportional to variance vᵢ was performed. The distribution of the noise matrix N as ˜N(0, V) where V is a matrix with diagonal elements [v₉, . . . , v₁₆] and all other elements are 0 may now be described. This is denoted as V=diag([v₉, . . . ,v₁₆]). Similarly, let W=diag([1/v₉, . . . ,1/v₁₆]). Now it is possible to solve for P using a weighted regression:
P=(X′WX)⁻¹ X′WY

It is straightforward to show that the variance of P will be
Var(P)=(X′WX)⁻¹
which can be used to indicate the confidence in the determination of P.

To summarize, we have used the data from individual genes (A: f₁, . . . ,f₄,B: f₅, . . . ,f_{B}), together with data from the combination of A and B (AB:f₉, . . . ,f₁₆) to help with estimating the probabilities for combination of A and B (p₉, . . . ,p₁₆) and their variances (v₉, . . . ,v₁₆). Finally, in our studies we mostly deal with log odds ratios, not probabilities, so we need to translate these probabilities into LORs. Generally, given the probabilities and variances for an event H as below.

| | D+ | D− |
|---|---|---|
| H+ | p1 | p2 |
| H− | 1 − p1 | 1 − p2 |
| V | v1 | v2 |

The formula for the LOR is LOR=[log(p1)−log(1−p1)]−[log(p2)−log(1−p2)], with variance (by delta method). V=[(p1)⁻¹+(1−p1)⁻¹]²*V(p1)+[(p2)⁻¹+(1−p2)⁻¹]²*V(p2). The table below shows the probabilities, corresponding LOR and variance for combination of A,B

| | D+ | D− | LOR | Var |
|---|---|---|---|---|
| A+B+ | P₉ | p₁₀ | lor₁ | V₁ = [1/p₉ + 1/(1 − p₉)]²v₉ + |
| | | | | [1/p₁₀ + 1/(1 − p₁₀)]²v₁₀ |
| A+B− | P₁₁ | p₁₂ | lor₂ | V₂ = [1/p₁₁ + 1/(1 − p₁)]²v₁ + |
| | | | | [1/p₁₂ + 1/(1 − p₁₂)]²v₁₂ |
| A−B+ | P₁₃ | p₁₄ | lor₃ | V₃ = [1/p₁₃ + 1/(1 − p₁₃)]²v₃ + |
| | | | | [1/p₁₄ + 1/(1 − p₁₄)]²v₁₄ |
| A−B- | P₁₅ | p₁₆ | lor₄ | V₄ = [1/p₁₅ + 1/(1 − p₁₅)]²v₁₅ + |
| | | | | [1/p₁₆ + 1/(1 − p₁₆)]²v₁₆ |

This provides an estimate of the log odds ratios and respective variances.

As an illustration of this method, the technique was employed to obtain improved estimates of P(A,B/D) where D represents the state of having Alzheimers and where A and B represents two different states of the APOE and ACE gene respectively. Table 2 represents three different studies conducted by Alvarez in 1999 where only gene A was sampled; by Labert in 1998 where only gene B was sampled; and by Farrer in 2005 where genes A and B were sampled. Two sets of results have been generated from these studies, and are shown in Table 3. The first set (See Table 3, columns 2, 3, 4 and 5) analyzes all the cohorts and improves estimates of P(A,B/D) given P(A/D) and P(B/D) using the methods disclosed here. The second set (see Table 3, columns 6, 7, 8 and 9) uses only those results generated from the modern cohort of Farrer (2005) for P(A,B/D) in which both genes were sampled. The confidence bounds of predictions in the former case are considerably reduced. Note that these predictions can be further improved using data describing P(A/B) from public sources—these measurements can be added to the X matrix as described above. Note also that the techniques described here may be used to improve the estimates on the separate A, B probabilities such as P(A+/D+), P(A+/D−), P(B+/D+), and P(B−/D−) using the relationship such as p1=p5+p7 as described above.

Note that while this method has been illustrated for only two variables A and B, it should be noted that the contingency tables can included many different IVs such as those mentioned above in the context of Alzheimer's prediction: family history of Alzheimer's, gender, race, age, and the various alleles of three genes, namely APOE, NOS3, and ACE. Continuous variables such as age can be made categorical by being categorized in bins of values in order to be suitable to contingency table formulation. In a preferred embodiment, the maximum number of IV's is used to model the probability of an outcome, with the standard deviation of the probability typically being below some specified threshold. In other words, the most specific contingencies possible may be created given the IV's available for a particular patient, while maintaining enough relevant training data for that contingency to make the estimate of the associated probability meaningful.

Note that it will also be clear to one skilled in the art, after reading this disclosure, how a similar technique for using data about disease-gene associations, gene-gene associations, and/or gene frequencies in the population can be applied to improve the accuracy of multivariable linear and nonlinear regression and logistic regression models. Furthermore, it will be clear to one skilled in the art, after reading this disclosure, how a similar technique for using data about disease-gene associations, gene-gene associations, and/or gene frequencies in the population can be applied to improve the accuracy of multivariable linear and nonlinear regression and logistic regression models by enabling the leveraging of outcome data to train the models where not all the independent variables of that are relevant to the model were measured for that outcome data. These techniques will be particularly relevant to leveraging data from the HapMap project and other data contained in public databases such as National Center for Biotechnology Information (NCBI) Online Mendelian Inheritance in Man (OMIM) and dbSNP databases.

Note also, throughout the patent, that where we refer to data pertaining to an individual or a subject, this also assumes that the data may refer to any pathogen that may have infected the subject or any cancer that is infecting the subject. The individual or subject data may also refer to data about a human embryo, a human blastomere, a human fetus, some other cell or set of cells, or to an animal or plant of any kind.

Tomorrow's Data: Modeling Multi-factorial Phenotype with Regression Models

As more data is accumulated correlating genotype with multi-factorial phenotype, the predominant scenario will become (iii) as described above, namely it will be desirable to consider complex combinations of genetic markers in order to accurately predict phenotype, and multidimensional linear or nonlinear regression models will be invoked. Typically, in training a model for this scenario, the number of potential predictors will be large in comparison to the number of measured outcomes. Examples of the systems and methods described here include a novel technology that generates sparse parameter models for underdetermined or ill-conditioned genotype-phenotype data sets. The technique is illustrated by focusing on modeling the response of HIV/AIDS to Anti-Retroviral Therapy (ART) for which much modeling work is available for comparison, and for which data is available involving many potential genetic predictors. When tested by cross-validation with actual laboratory measurements, these models predict drug response phenotype more accurately than models previously discussed in the literature, and other canonical techniques described here.

Two regression techniques are described and illustrated in the context of predicting viral phenotype in response to Anti-Retroviral Therapy from genetic sequence data. Both techniques employ convex optimization for the continuous subset selection of a sparse set of model parameters. The first technique uses the Least Absolute Shrinkage and Selection Operator (LASSO) which applies the I¹ norm loss function to create a sparse linear model; the second technique uses the Support Vector Machine (SVM) with radial basis kernel functions, which applies the ε-insensitive loss function to create a sparse nonlinear model. The techniques are applied to predicting the response of the HIV-1 virus to ten Reverse Transcriptase Inhibitors (RTIs) and seven Protease Inhibitor drugs (PIs). The genetic data is derived from the HIV coding sequences for the reverse transcriptase and protease enzymes. Key features of these methods that enable this performance are that the loss functions tend to generate simple models where many of the parameters are zero, and that the convexity of the cost function assures that one can find model parameters to globally minimize the cost function for a particular training data set.

The LASSO and the L¹ Selection Function

When the number of predictors M exceeds the number of training samples N, the modeling problem is overcomplete, or ill-posed, since any arbitrary subset of N predictors is sufficient to yield a linear model with zero error on the training data, so long as the associated columns in the X matrix are linearly independent. Consequently, one is disinclined to put faith in an N-predictor model returned by a linear regression method. Suppose, however, a model with significantly fewer than N variables has low training error. The more sparse the model, the less probable that low training error could be a chance artifact; hence the more likely that the predictors are causally related to the dependent variable. This underlies the importance of sparse solutions in overcomplete problems, as is the case for the RTI data. A similar argument can be applied to ill-conditioned problems characterized by a large condition number on the matrix X^{T} X, as is the case for the PI data. In this case, the estimated parameters \hat{b} are highly susceptible to the model error, as well as to measurement noise, and as a result are unlikely to generalize accurately. Overcomplete and ill-conditioned problems are typical of genetic data, where the number of possible predictors—genes, proteins, or, in our case, mutation sites—is large relative to the number of measured outcomes.

One canonical approach to such cases is subset selection. For example, with stepwise selection, at each step a single predictor is added to the model, based on having the highest F-test statistic indicating the level of significance with which that variable is correlated with prediction error. After each variable is added, the remaining variables may all be checked to ensure that none of them have dropped below a threshold of statistical significance in their association with the prediction error of the model. This technique has been successfully applied to the problem of drug response prediction. However, due to the discrete nature of the selection process, small changes in the data can considerably alter the chosen set of predictors. The presence or absence of one variable may affect the statistical significance associated with another variable and whether that variable is included or rejected from the model. This affects accuracy in generalization, particularly for ill-conditioned problems.

Another approach is for the values of the estimated parameters \hat{b} to be constrained by means of a shrinkage function. A canonical shrinkage function is the sum of the squares of the parameters, and this is applied in ridge regression which finds the parameters according to:
\hat{b}=arg minₕ∥y−Xb∥²+λ∥b∥² (1)
where λ is a tuning parameter, typically determined by cross-validation. This method is non-sparse and does not set parameters to 0. This tends to undermine accuracy in generalization, and makes solutions difficult to interpret.

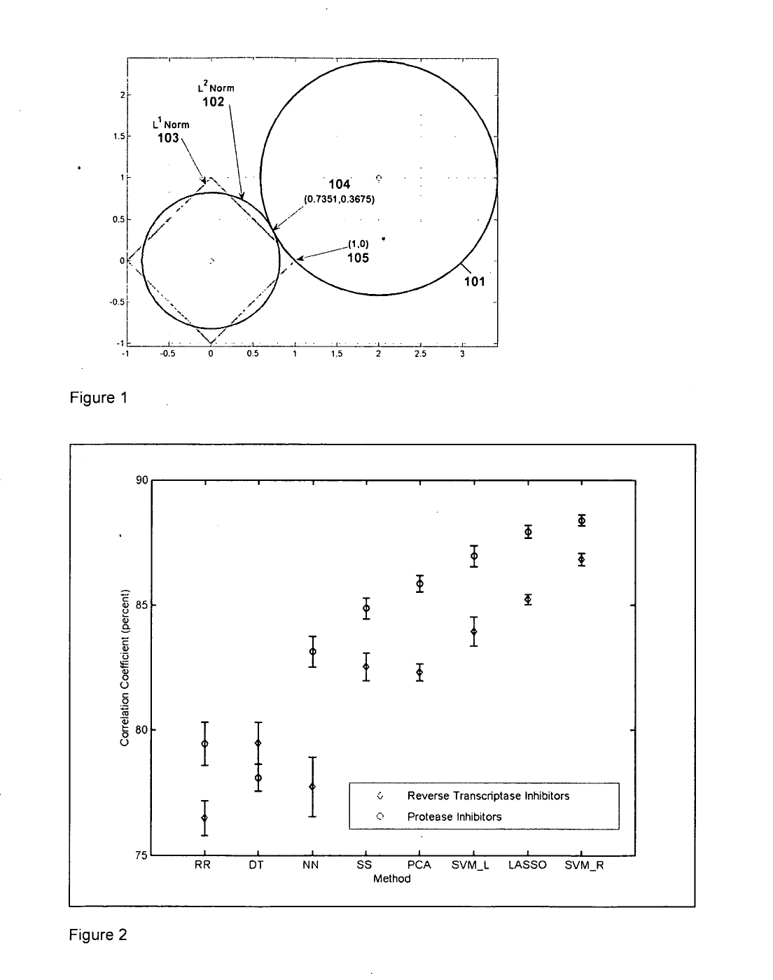

These problems are addressed by the LASSO technique. In contrast to subset selection, the LASSO does not perform discrete acceptance or rejection of predictor variables; rather it allows one to select en-masse, via a continuous subset optimization, the set of variables that together are the most effective predictors. It uses the I¹ norm shrinkage function:

$$\hat{b} = arg {min}_{h} {‖ y - Xb ‖}^{2} + λ {\sum }_{i = l … M} \vert {b}_{i} \vert \qquad ( 2 )$$

where λ is typically set by cross-validation. The LASSO will tend to set many of the parameters to 0. FIG. 1 provides insight into this feature of the LASSO, termed selectivity. Suppose that a model based on just two mutations is created with the training data X=[1 0; 01]^{T}, y=[2 1]^{T} and the x-axis and y-axis represent the two parameters b₁ and b₂ respectively. Compare the use of the I¹ and I² shrinkage functions, where in both cases a solution is found that fits the training data equally well such that ∥y−Xb∥²=2. The large circle 101, small circle 102, and square 103 respectively represent level curves for the cost functions ∥y−Xb∥², the I² norm ∥b∥², and the I¹ norm |b₁|+|b₂|. A solution for ridge regression (I²) is found where the two circles meet 104; a solution for the LASSO (I¹) is found where the square and the large circle intersect 105. Due to the “pointiness” of the level curve for the I¹ norm, a solution is found that lies on the axis b₁ and is therefore sparse. This argument, extended into higher dimensions, explains the tendency of LASSO to produce sparse solutions, and suggests why the results achieved are measurably better than those reported in the literature.

The I¹ norm can be viewed as the most selective shrinkage function, while remaining convex. Convexity guarantees that one can find the one global solution for a given data set. A highly efficient recent algorithm, termed Least Angle Regression, is guaranteed to converge to the global solution of the LASSO in M steps.

Note that it will be clear to one skilled in the art, after reading this disclosure, how the I¹ norm can also be used in the context of logistic regression to model the probability of each state of a categorical variable. In logistic regression, a convex cost function may be formed that corresponds to the inverse of the a-posteriori probability of a set of measurements. The a-posteriori probability is the probability of the observed training data assuming the models estimates of the likelihood of each outcome. By adding to the I¹ norm to the convex cost function, the resulting convex cost function can be minimized to find a sparse parameter model for modeling the probability of particular outcomes. The use of I¹ norm for logistic regression may be particularly relevant when the number of measured outcomes is small relative to the number of predictors.

Support Vector Machines and the L1-Norm

SVM's may be configured to achieve good modeling of drug response and other phenotypes, especially in cases where the model involves complex interactions between the independent variables. The training algorithm for the SVM makes implicit use of the I¹ norm selection function. SVM's are learning algorithms that can perform real-valued function approximation and can achieve accurate generalization of sample data even when the estimation problem is ill-posed in the Hadamard sense. The ability of SVM's to accurately generalize is typically influenced by two selectable features in the SVM model and training algorithm. The first is the selection of the cost function, or the function that is to be minimized in training. The second is the selection of the kernels of the SVM, or those functions that enable the SVM to map complex nonlinear functions, involving interactions between the independent variables, using a relatively small set of linear regression parameters. These features are discussed below.

Consider modeling the phenotype for a subject i yᵢ with a linear function approximation: ŷᵢ=f(xᵢ,b)=b^{T} xᵢ. First, estimate b by minimizing a cost function consisting of a I² shrinkage function on the parameters, together with the “ε-insensitive loss” function, which does not penalize errors below some ε>0. The SV regression may be formulated as the following optimization:

$$\hat{b} = arg {min}_{h , {ξ}^{-} , {ξ}^{+}} \frac{{‖ b ‖}^{2}}{2} + C {\sum }_{i = 1}^{N} ( {ξ}_{i}^{-} + {ξ}_{i}^{+} ) \qquad ( 2 )$$

subject to the constraints:
yᵢ−b^{T} xᵢ≦ε+ξᵢ⁺, i=1 . . . N (4)
b^{T} xᵢ−yᵢ≦ε+ξᵢ⁻, i=1 . . . N (5)
ξᵢ⁺≧0, ξᵢ⁻≧0, i=1 . . . N (6)

The second term of the cost function minimizes the absolute value of the modeling errors, beyond the “insensitivity” threshold ε. Parameter C allows one to scale the relative importance of the error vs. the shrinkage on the weights. This constrained optimization can be solved using the standard technique of finding the saddle-point of a Lagrangian, in order to satisfy the Kuhn-Tucker constraints. The Lagrangian, which accommodates the cost and the constraints described above, is:

$$\begin{matrix}L ( b , {ξ}^{+} , {ξ}^{-} , {α}^{+} , {α}^{-} , {λ}^{+} , {λ}^{-} ) = \frac{{‖ b ‖}^{2}}{2} + C {\sum }_{i = 1}^{N} ( {ξ}_{i}^{-} + {ξ}_{i}^{+} ) - \\ {\sum }_{i = 1}^{N} {α}_{i}^{-} ( {y}_{i} - {b}^{T} x + ɛ + {ξ}_{i}^{-} ) - \\ {\sum }_{i = 1}^{N} {α}_{i}^{-} ( {y}_{i} - {b}^{T} x + ɛ + {ξ}_{i}^{-} ) - \\ {\sum }_{i = 1}^{N} ( {λ}_{i}^{-} {ξ}_{i}^{-} + {λ}_{i}^{+} {ξ}_{i}^{+} )\end{matrix} \qquad ( 7 )$$

Minimize with respect to the vectors of parameters b, ξ⁻, ξ⁺, and maximize with respect to the vectors of Lagrange multipliers α⁻, α⁺, λ⁻, λ⁺. Note that the Lagrange multipliers are desirably positive in accordance with the Kuhn-Tucker constraints. Hence, the optimal set of parameters can be found according to:
(b*,ξ*⁺,ξ*⁻)=arg min_{b,ξ}_{⁺}_{,ξ}_{^{−}} max_{α}_{⁺}_{,α}_{^{−}}_{,β}_{⁺}_{,β}_{^{−}}L(b,ξ⁻,ξ⁺,α⁺,α⁻,λ⁺,λ⁻) (8)
subject to
αᵢ⁺,αᵢ⁻,λᵢ⁺,λᵢ⁻≧0, i=1 . . . N (9)

Since the order of minimization/maximization can be interchanged, first minimize with respect to variables b,ξᵢ⁺,ξᵢ⁻ by setting the partial derivatives of L with respect to these variables to 0. From the resultant equations, one finds that the weight vector can be expressed in terms of

$$b = {\sum }_{i = 1}^{N} ( {α}_{i}^{+} - {α}_{i}^{-} ) {x}_{i} \qquad ( 10 )$$

Also from the resultant equations, eliminate variables from the Lagrangian so that one may find the coefficients αᵢ⁺,αᵢ⁻, i=1 . . . N by maximizing the quadratic form:

$$\begin{matrix}W ( {α}^{+} , {α}^{-} ) = - {\sum }_{i = 1}^{N} ɛ ( {α}_{i}^{-} + {α}_{i}^{+} ) + {\sum }_{i = 1}^{N} {y}_{i} ( {α}_{i}^{+} - {α}_{i}^{-} ) - \\ \frac{1}{2} {\sum }_{i , j = 1}^{N} ( {α}_{i}^{-} + {α}_{i}^{+} ) ( {α}_{i}^{-} + {α}_{i}^{+} ) {x}_{i}^{T} {x}_{j}\end{matrix} \qquad ( 11 )$$

subject to

$$\begin{matrix}{\sum }_{i = 1}^{N} {α}_{i}^{+} = {\sum }_{i = 1}^{N} {α}_{i}^{-} & ( 12 ) \\ 0 \leq {α}_{i}^{+} \leq C , i = 1 … N & ( 13 ) \\ 0 \leq {α}_{i}^{-} \leq C , i = 1 … N & ( 14 )\end{matrix}$$

This enables the vector b to be computed and fully defines the SVM model for the ε-insensitive loss function. Note from equation (11) that the model may be characterized as

$$f ( x ) = {\sum }_{i = 1}^{M} {β}_{i} ( {x}^{T} {x}_{i} ) + {b}_{0} \qquad ( 15 )$$

where βᵢ=αᵢ⁺−αᵢ⁻. The resulting model will tend to be sparse in that many of the parameters in the set {βᵢ, i=1 . . . M} will be 0. Those vectors xᵢ corresponding to non-zero valued βᵢ are known as the support vectors of the model. The number of support vectors depends on the value of the tunable parameter C, the training data, and the suitability of the model. In an illustration below, it is shown how the model can now be augmented to accommodate complex nonlinear functions with the use of kernel functions. Next, it will be shown that the ε-insensitive loss function is related to the I¹ norm shrinkage function, and essentially achieves the same thing, namely the en-masse selection of a sparse parameter set by means of the I¹ norm.

In order to model a complex function, with possible coupling between variables, the simple inner product of Equation (17) is replaced with a kernel functions that computes a more complex interaction between the vectors. Inserting kernel functions, our function approximation in (17) takes the form:

$$f ( x ) = {\sum }_{i = 1}^{N} {β}_{i} K ( x , {x}_{i} ) + {β}_{0} = {\sum }_{i = 0}^{N} {β}_{i} K ( x , {x}_{i} ) \qquad ( 16 )$$

where K(x,x₀)=1 by definition. To find these parameters, use exactly the same optimization methods described above, and replace all terms x^{T} xᵢ with K(x,xᵢ). As before, compute the parameter set according to βᵢ=αᵢ⁺−αᵢ⁻, by finding the arguments that maximize

$$\begin{matrix}W ( {α}^{+} , {α}^{-} ) = - {\sum }_{i = 1}^{N} ɛ ( {α}_{i}^{-} + {α}_{i}^{+} ) + {\sum }_{i = 1}^{N} {y}_{i} ( {α}_{i}^{+} - {α}_{i}^{-} ) - \\ \frac{1}{2} {\sum }_{i , j = 1}^{N} ( {α}_{i}^{-} + {α}_{i}^{+} ) ( {α}_{j}^{-} + {α}_{j}^{+} ) K ( {x}_{i}^{T} {x}_{j} )\end{matrix} \qquad ( 17 )$$

subject to the same constraints as above. For the SVM results described above, radial basis kernel functions were selected.

Now, to illustrate the implicit use of the I¹ norm: consider that instead of trying to optimize equation (17) one begins, with the optimization:

$${β}^{*} = arg {min}_{β} {\int }_{- ∞}^{∞} {( f ( x ) - {\sum }_{i = 0}^{N} {β}_{i} K ( {x}_{i} , x ) )}^{2} ⅆ x + ɛ {\sum }_{i = 0}^{N} \vert {β}_{i} \vert \qquad ( 18 )$$

where the I¹ shrinkage has been explicitly used to constrain the values of β, and the data fitting error, instead of being defined over discrete samples of training data, is defined over the domain of the hypothetical function being modeled. Now, make the variable substitutions: βᵢ=αᵢ⁺−αᵢ⁻; αᵢ⁺,αᵢ⁻≧0, αᵢ⁺αᵢ⁻≧0, i=1 . . . N. Then the optimization may be recast as:

$$W ( {α}^{+} , {α}^{-} ) = - {\sum }_{i = 1}^{N} ɛ ( {α}_{i}^{-} + {α}_{i}^{+} ) + {\sum }_{i = 1}^{N} {y}_{i} ( {α}_{i}^{+} - {α}_{i}^{-} ) - \frac{1}{2} {\sum }_{i , j = 1}^{N} ( {α}_{i}^{-} - {α}_{i}^{-} ) ( {α}_{j}^{-} - {α}_{j}^{+} ) K ( {x}_{i} , {x}_{j} ) \qquad ( 19 )$$

subject to the constraints
αᵢ⁺,αᵢ⁻≧0 (20)
αᵢ⁺,αᵢ⁻=0 (21)

This solution, which has different constraints, will nonetheless coincide with that of the ε-insensitive loss function if both the value C for the SV method is chosen sufficiently large that the constraints 0≦αᵢ⁺,αᵢ⁻≦C can simply become the constraints (21) and (22) and also one of the basis functions is constant, as in equation (17) for our case. In this case, one does not require the additional constraint

$${\sum }_{i = 1}^{N} {α}_{i}^{+} = {\sum }_{i = 1}^{N} {α}_{i}^{-}$$

that is used by the SV method. Note that constraint (25) is already implicit in Equations (15) since the constraints (8) and (9) cannot be simultaneously active, so one of the Lagrange multipliers αᵢ⁺ or αᵢ⁻ should be slack, or 0.

Under these conditions, one can see that the ε-insensitive loss function achieves sparse function approximation, implicitly using the approach of an I¹ shrinkage function.

Example of Multi-Factorial Phenotype Prediction: Modeling HIV-1 Drug Response

Current approaches to predicting phenotypic outcomes of salvage ART do not demonstrate good predictive power, largely due to a lack of statistically significant outcome data, combined with the many different permutations of drug regimens and genetic mutations. This field has a pressing need both for the integration of multiple heterogeneous data sets and the enhancement of drug response prediction.

The models demonstrated herein used data from the Stanford HlVdb RT and Protease Drug Resistance Database for training and testing purposes. This data consists of 6644 in vitro phenotypic tests of HIV-1 viruses for which reverse transcriptase (RT) or protease encoding segments have been sequenced. Tests have been performed on ten reverse transcriptase inhibitors (RTI) and seven protease inhibitors (PI). The RTIs include lamivudine (3TC), abacavir (ABC), zidovudine (AZT), stavudine (D4T), zalcitabine (DDC), didanosine (DDI), delaviradine (DLV), efavirenz (EFV), nevirapine (NVP) and tenofovir (TDF). The PIs include ampranavir (APV), atazanavir (ATV), nelfinavir (NFV), ritonavir (RTV), saquinavir (SQV), lopinavir (LPV) and indinavir (IDV)).

For each drug, the data has been structured into pairs of the form (xᵢ,yᵢ), i=1 . . . N, where N is the number of samples constituting the training data, yᵢ is the measured drug fold resistance (or phenotype), and xᵢ is the vector of mutations plus a constant term, xᵢ=1 xᵢ₁,xᵢ₂ . . . x_{iM}]^{T}, where M is the number of possible mutations on the relevant enzyme. Assume element xᵢₘ=1 if the m^{th} mutation is present on i^{th} sample, and set xᵢₘ=0 otherwise. Each mutation is characterized both by a codon locus and a substituted amino acid. Mutations that do not affect the amino acid sequence are ignored. Note that only mutations present in more than 1% percent of the samples for each drug are included in the set of possible predictors for a model, since it is improbable that mutations associated with resistance would occur so infrequently. The measurement yᵢ represents the fold resistance of the drug for the mutated virus as compared to the wild type. Specifically, yᵢ is the log of the ratio of the IC₅₀ (the concentration of the drug required to slow down replication by 50%) of the mutated virus, as compared to the IC₅₀ of the wild type virus. The goal is to develop a model for each drug that accurately predicts yᵢ from xᵢ. In order to perform batch optimization on the data, stack the independent variables in an N by M+1 matrix, X=[x₁,x₂ . . . x_{N}], and stack all observations in a vector y=[y₁,y₂ . . . y_{N}]^{T}.

The performance of each algorithm is measured using cross-validation. For each drug, the first-order correlation coefficient R is calculated between the predicted phenotypic response of the model and the actual measured in vitro phenotypic response of the test data.

$$R = \frac{{( \hat{y} - \overline{\hat{y}} {I}^{->} )}^{T} ( y - \overline{y} {I}^{->} )}{{‖ \hat{y} - {y}^{\overline{\hat{}}} {I}^{->} ‖}_{2} {‖ y - \overline{y} {I}^{->} ‖}_{2}} \qquad ( 22 )$$

Where vector ŷ is the prediction of phenotypes y, y̅ denotes the mean of the elements in vector y and \vec{1} denotes the vector of all ones. For each drug and each method, the data is randomly subdivided in the ratio 9:1 for training and testing, respectively. In one example, ten different subdivisions are performed in order to generate the vector ŷ and R without any overlap of training and testing data. This entire process may then be repeated ten times to generate ten different values of R. The ten different values of R are averaged to generate the R reported. The standard deviation of R is also determined for each of the models measured over the ten different experiments to ensure that models are being compared in a statistically significant manner.

Table 4 displays the results of the above mentioned models for the PI drugs; Table 5 displays the results for the ten RTI drugs. Results are displayed in terms of correlation coefficient R, averaged over ten subdivisions of the training and test data. The estimated standard deviation of the mean value of R, computed from the sample variance, is also displayed. The number of available samples for each drug is shown in the last row. The methods tested, in order of increasing average performance, are: i) RR—Ridge Regression, ii) DT—Decision Trees, iii) NN—Neural Networks, iv) PCA—Principal Component Analysis, v) SS—Stepwise Selection, vi) SVM_L—Support Vector Machines with Linear Kernels, vii) LASSO—Least Absolute Shrinkage and Selection Operator, and viii) SVM—Support Vector Machines with Radial Basis Kernels. The information in the last columns of Table 4 and Table 5 is depicted in FIG. 2. The circles (blue) in FIG. 2 display the correlation coefficient R averaged over ten different experiments for each PI, and averaged over the seven different PIs. The diamonds (red) in FIG. 2 display the correlation coefficient R averaged over ten different experiments for each RTI, and averaged over the ten different RTIs. The one standard deviation error bars are also indicated.

Wherever modeling techniques involve tuning parameters, these have been adjusted for optimal performance of the technique as measured by cross-validation, using a grid search approach. In all cases, the grid quantization was fine enough that the best performing parameters from the grid were practically indistinguishable from the optimal parameters for the given data, since the difference in the prediction due to grid quantization lay below the experimental noise floor.

Although there are strong trends in the data, it should be noted that due to differences in the number of samples, interactions of the underlying genetic predictors, and other idiosyncrasies in the data that vary between drugs, the R achieved by each algorithm may vary from drug to drug. This variation may be seen by studying the individual drug columns of Table 4 (columns 3 to 9) and Table 5 (columns 3 to 12).

Of all the methods, SVM performs best, slightly outperforming LASSO (P<0.001 for the RTIs; P=0.18 for the PIs). The performance of SVM trained with the ε-insensitive loss function is considerably better than that of previously reported methods based on the support vector machine. SVM, which uses nonlinear kernel functions, outperforms SVM_L which uses linear kernel functions, and which is also trained using the ε-insensitive loss function (P=0.003 for RTIs; P<0.001 for PIs). The SVM considerably outperforms the other nonlinear technique which uses neural networks and which does not create a convex cost function (P<0.001 for both RTIs and PIs). The LASSO technique, which trains a linear regression model using a convex cost function and continuous subset selection, considerably outperforms the SS technique (P<0.001 for both PIs and RTIs). The top five methods, namely SS, PCA, SVM_L, LASSO, SVM_R, all tend to generate models that are sparse, or have a limited number of non-zero parameters.

In order to illustrate the subset of mutations selected as predictors, certain embodiments disclosed herein focus on the second-best performing model, namely the LASSO, which creates a linear regression model that, unlike SVM, does not attempt to emulate nonlinear or logical coupling between the predictors. Consequently, it is straightforward to show how many predictors are selected. Table 6 shows the number of mutations selected by the LASSO as predictors for each PI drug (Table 6, row 4), together with the number of mutations (Table 6, row 3), and the total number of samples (Table 6, row 2), used in training each model. The same table is shown for the RTIs (Table 7, same rows correspond to the same items).

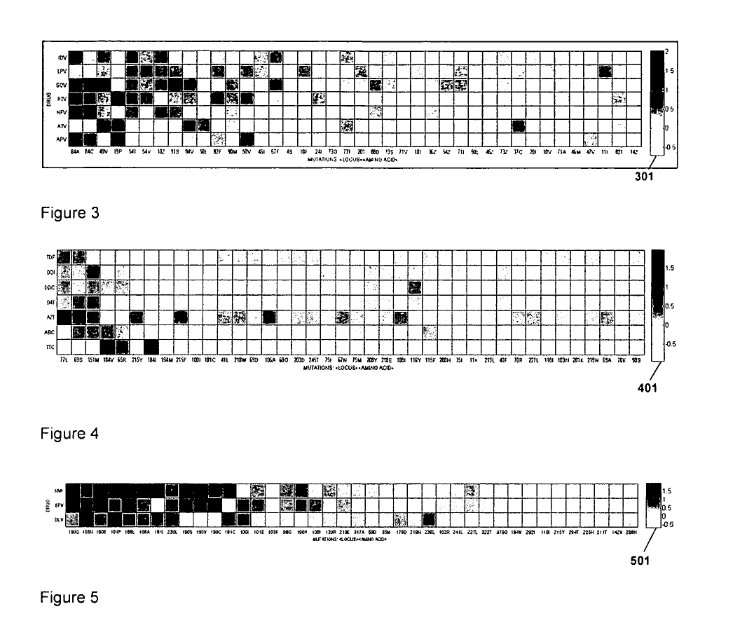

The selected mutations may also enhance understanding of the causes of drug resistance. FIGS. 3, 4 and 5 show the value of the parameters selected by the LASSO for predicting response to PI, Nucleoside RTIs (NRTIs) and Non-Nucleoside RTIs (NNRTIs) respectively. Each row in the figures represents a drug; each column represents a mutation. Relevant mutations are on the protease enzyme for PI drugs, and on the RT enzyme for NRTI and NNRTI drugs. The shading of each square indicates the value of the parameter associated with that mutation for that drug. As indicated by the color-bar on the right (301, 401 and 501, respectively), those predictors that are shaded darker are associated with increased resistance; those parameters that are shaded lighter are associated with increased susceptibility. The mutations are ordered from left to right in order of decreasing magnitude of the average of the associated parameter. The associated parameter is averaged over all rows, or drugs, in the class. Those mutations associated with the forty largest parameter magnitudes are shown. Note that for a particular mutation, or column, the value of the parameter varies considerably over the rows, or the different drugs in the same class.

For the algorithms RR, DT, NN, and SS, the model was not trained on all genetic mutations, but rather on a subset of mutations occurring at those sites that have been determined to affect resistance by the Department of Health and Human Services (DHHS). The reduction in the number of independent variables was found to improve the performance of these algorithms. In the case of the SVM_L algorithm, best performance for RTIs was achieved using only the DHHS mutation subset, while best performance for PIs was achieved by training the model on all mutations. For all other algorithms, best overall performance was achieved by training the model on all mutations.

The set of mutations shown in FIGS. 3, 4 and 5 that were selected by the LASSO as predictors, but are not currently associated with loci determined by the DHHHS to affect resistance, are: for PIs—19P, 91S, 67F, 4S, 37C, 11I, 14Z; for NRTIs—68G, 203D, 245T, 208Y, 218E, 208H, 35I, 11K, 40F, 281K; and for NNRTIs—139R, 317A, 35M, 102R, 241L, 322T, 379G, 292I, 294T, 211T, 142V. Note that in some cases, such as for the LASSO and the SVM, the performance for particular drugs, such as LPV, was significantly improved (P<0.001) when all mutations were included in the model (R=86.78, Std. dev=0.17) as compared to the case when only those loci recognized to affect resistance by DHHS were included (R=81.72, Std. dev.=0.18). This illustrates that other mutations, beyond those recognized by the DHHS, may play a role in drug resistance.

The use of convex optimization techniques has herein been demonstrated to achieve continuous subset selection of sparse parameter sets in order to train phenotype prediction models that generalize accurately. The LASSO applies the 11 norm shrinkage function to generate a sparse set of linear regression parameters. The SVM with radial basis kernel functions and trained with the E-insensitive loss function generates sparse nonlinear models. The superior performance of these techniques may be explained in terms of the convexity of their cost functions, and their tendency to produce sparse models. Convexity assures that one can find the globally optimal parameters for a particular training data set when there are many potential predictors. Sparse models tend to generalize well, particularly in the context of underdetermined or ill-conditioned data, as is typical of genetic data. The I¹ norm may be viewed as the most selective convex function. The selection of a sparse parameter set using a selective shrinkage function exerts a principle similar to Occam's Razor: when many possible theories can explain the observed data, the most simple is most likely to be correct. The SVM, which uses an I² shrinkage function together with an ε-insensitive loss function, tends to produce an effect similar to the explicit use of the I¹ norm as a shrinkage function applied to the parameters associated with the support vectors.

Techniques using the I¹ shrinkage function are often able to generalize accurately when the number of IVs is large, and the data is undetermined or ill-conditioned. Consequently, it is possible to add nonlinear or logical combinations of the independent variables to the model, and expect that those combinations that are good predictors will be selected in training. The SVM is able to model interactions amongst the independent variables with the use of nonlinear kernel functions, such as radial basis functions, which perform significantly better than linear kernel functions. Consequently, without changing the basic concepts disclosed herein, the performance of the LASSO may be enhanced by adding logical combinations of the independent variables to the model. Logical terms can be derived from those generated by a decision tree, from those logical interactions described by expert rules, from the technique of logic regression, or even from a set of random permutations of logical terms. An advantage of LASSO is that the resulting model will be easy to interpret, since the parameters directly combine independent variables, or expressions involving independent variables, rather than support vectors. The robustness of the LASSO to a large number of independent variables in the model is due both to the selective nature of the I¹ norm, and to its convexity.

Other techniques exist that use shrinkage function more selective than the I¹ norm. For example, log-shrinkage regression uses a shrinkage function derived from coding theory which measures the amount of information residing in the model parameter set. This technique uses the log function as a shrinkage function instead of the I¹-norm and is consequently non-convex. While offering a theoretically intriguing approach for seeking a sparse set of parameters, the non-convexity of the penalty function means that solving the corresponding regression is still computationally less tractable than the LASSO, and for large sets of predictors may yield only a local rather than a global minimum for the given data.

The techniques described here may be applied to creating linear and nonlinear regression models for a vast range of phenotype prediction problems. They are particularly relevant when the number of potential genetic predictors is large compared to the number of measured outcomes.

Simplifying a Regression Model by Mapping Genetic Independent Variables into a Different Space

Note that, as described above, in cases where complex combinations of genetic markers are considered, it is possible to project the SNP variables onto another variable space in order to simplify the analysis. This variable space may represent known patters of mutations, such as the clusters or bins described by the HapMap project. In other words, rather than the vector xᵢ representing particular SNP mutations as described above, it may represent whether the individual falls into particular HapMap clusters or bins. For example, following the notation above, imagine there is a vector xᵢ=[xᵢ₁, xᵢ₂ . . . x_{iB}]^{T} where B is the number of relevant HapMap bins. One can set element X_{ib}=1 if the individuals SNPS pattern falls into the b^{th} bin and 0 otherwise. Alternatively, if the overlap between the individuals SNPs and a particular bin is incomplete, and it may not be desirable to simply place the individual in a category “other”, then one may set each x_{ib} equal to the fraction of overlap between his pattern of SNPs and that of bin b. Many other techniques are possible to formulate the regression problem without changing the concepts disclosed herein.

Model Selection by Cross Validation for Outcome Prediction

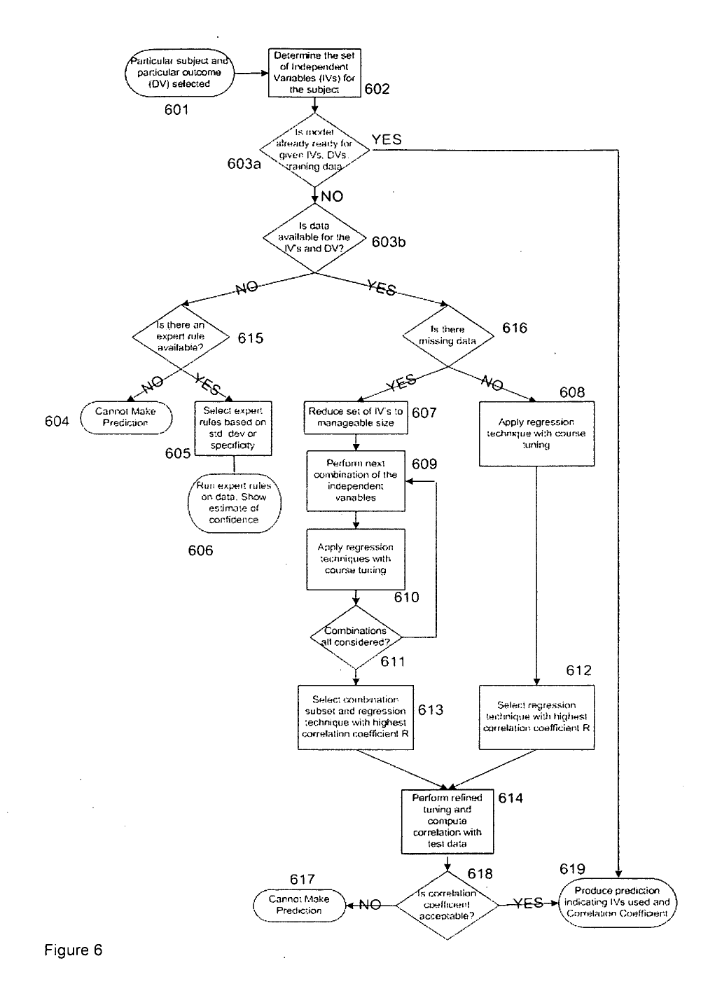

In what has preceded this discussion, different phenotype prediction techniques involving expert rules, contingency tables, linear and nonlinear regression were described. Now a general approach to selecting from a set of modeling techniques which is best to model a particular categorical or non-categorical outcome for a particular subject is described, based on the use of training data. FIG. 6 provides an illustrative flow diagram for the system. The process described in FIG. 6 is a general approach to selecting the best model given the data that is available for a particular patient, the phenotype being modeled, and a given set of testing and training data, and the process is independent of the particular modeling techniques. In a preferred embodiment the set of modeling techniques that may be used include expert rules, contingency tables, linear regression models trained with LASSO or with simple least-squares where the data is no under-determined, and nonlinear regression models using support vector machines.

The process begins 601 with the selection of a particular subject and a particular dependent variable (DV) that will be modeled, or—if it's a categorical variable—for which the probability may be modeled. The system then determines 602 the set of Independent Variables (IVs) that are associated with that subject's record and which may be relevant to modeling the outcome of the DV. The human user of the system may also select that subset of IVs that the user considers to be possible relevant to the model. The system then checks 603a to see whether a model has already been trained and selected for the given combination of independent variables and the given dependent variable to be modeled. If this is the case, and the data used for training and testing the ready-made model is not out of date, the system will go directly to generating a prediction 619 using that model. Otherwise, the system will extract from the database all other records that have the particular DV of interest and which may or may not have the same set of IV's as the particular subject of interest. In so doing, the system determines 603b whether data is available for training and testing a model. If the answer is no, the system checks 615 to see if there are any expert rules available to predict the outcome based on a subset of the IV's available for the subject. If no expert rules are available then the system exits 604 and indicates that it cannot make a valid prediction. If one or more expert rules are available, then the system will select 605 a subset of expert rules that are best suited to the particular subject's data. In a preferred embodiment, the selection of which expert rule to apply to a subject will be based on the level of confidence in that expert rule's estimate. If no such confidence estimate is available, the expert rules can be ranked based on their level of specificity, namely based on how many of the IVs available for the subject of interest the expert rules uses in the prediction. The selected subset of expert rules is then used to generate a prediction 606.

If it is determined 603b that data is available, the system will check 616 to determine whether or not there is any data missing in the test and training data. In other words, for all those records that include the relevant DV, the system will check to see if all those records have exactly the same set of IVs as are available for the patient of interest and which may be potential predictors in the model. Typically, the answer will be ‘no’ since different information will be available on different patients. If there is missing data, the system will go through a procedure to find that subset of IV's that should be used to make the best possible prediction for the subject. This procedure is time-consuming since it involves a multiple rounds of model training and cross-validation. Consequently, the first step in this procedure is to reduce 607 the set of IVs considered to a manageable size based on the available computational time. In a preferred embodiment, the set of IVs are reduced based on there being data on that IV for a certain percentage of the subjects that also have the DV available. The set of lVs can be further reduced using other techniques that are known in the art such as stepwise selection which assumes a simple linear regression model and selects IVs based on the extent to which they are correlated with the modeling error. The system then enters a loop in which every combination of the remaining IVs is examined. In a preferred embodiment the following states for each IV and the DV are considered: each IV can either be included or not included in the model and for numerical data for an IV or DV that is positive for all subjects, the data may or may not be preprocessed by taking its logarithm. For each particular combination of inclusions/exclusions and pre-processing of the IVs and the DV, a set of modeling technique is applied 610.

Most modeling techniques will have some tuning parameter that can be optimized or tuned based on a grid-search approach using cross-validation with the test data. For example, for the LASSO technique discussed above, many values will be explored for the variable parameter λ. For each value of λ, the regression parameters may be trained, and the model predictions may be compared with the measured values of test data. Similarly, for the support vector machine approach discussed above, the tuning parameters to be optimized using a grid-search approach include C, ε and possibly parameters describing the characteristics of the kernel functions. For techniques based on contingency tables, the tunable parameter may correspond to the highest standard deviation that can be accepted from a contingency table model, while making the contingencies as specific as possible for the given subject, as discussed above.

Many different metrics may be used to compare the model predictions with test data in order to optimize the tunable parameters and select among models. In a preferred embodiment, the standard deviation of the error is used. In other embodiments, one may use the correlation coefficient R between the predicted and measured outcomes. In the context of logistic regression or contingency tables, one may also use the maximum a-posteriori probability, namely the probability of the given set of test data assuming the model's prediction of the likelihood of each test outcome. Whatever metric is used, that value of the tuning parameter is selected that optimizes the value of the metric, such as minimizing the standard deviation of the prediction error if the standard deviation of the prediction error is used as a test metric. Since model training and cross-validation is a slow process, at this stage 610 the grid that defines the different tuning parameters to be examined is set coarsely, based on the amount of available time, so that only a rough idea of the best model and best tuning parameters can be obtained.

Once all the different IV/DV combinations have been examined in this way 611, the system selects that combination of IVs/DV, that model and those tuning parameters that achieved the best value of the test metric. Note that if there is no missing data then the system will skip the step of checking all combinations of the IVs/DV. Instead, the system will examine the different modeling techniques and tuning parameters 608, and will select that modeling method and set of tuning parameters that maximizes the test metric. The system then performs refined tuning of the best regression model, using a more finely spaced grid, and for each set of tuning parameter values, determines the correlation with the test data. The set of tuning parameters is selected that produces the best value of the test metric. The system then determines 618 whether or not the test metric, such as the standard deviation of the prediction error, is below or below a selected threshold so that the prediction can be considered valid. For example, in one embodiment, a correlation coefficient of R>0.5 is desirable for a prediction to be deemed valid. If the resultant test metric does not meet the threshold then no prediction can be made 617. If the test metric meets the requisite threshold, a phenotype prediction may be produced, together with the combination of IV's that was used for that prediction and the correlation coefficient that the model achieved with the test data.

Illustrating Model Selection by Cross Validation in Cancer Cohorts with Missing Data

In order to demonstrate this aspect, a focus was on utilizing the genetic and phenotypic data sets related to colon cancer that can be found in PharmGKB which is part of the National Institute of Health's Pharmacogenomic Research Network and has a mission to discover how individual genetic variations contribute to different drug response. For this dataset, a key challenge was missing information. Ideally, one would like to apply the regression techniques described above to automatically select an IV subset for the model from all IVs that are available on a particular patient. However, this limits the amount of data that is available from other patients for training and testing the model. Consequently, for datasets containing few enough lVs, it is possible to search through all possible subsets of the independent variables. For each, as described above, one can extract that set of patients for which the required outcome has been measured, and the relevant set of independent variables is available. As described above, one can also search the space of possible ways to preprocess the included independent variables, such as taking the logs of positive numeric independent variables. For each combination of independent variables included and independent variable preprocessing techniques, the model is trained and tested by cross-validation with test data. That model is selected which has the best cross-validation with test data. Once a model has been created for a given set on IVs, that model is applied to new patient data submitted with the same set of IVs without requiring the exhaustive model search.

This technique has been used to predict clinical side effects for colorectal cancer drug Irinotecan. Severe toxicity is commonly observed in cancer patients receiving Irinotecan. Data was included which describes the relationships between Irinotecan pharmacokinetics and side effects with allelic variants of genes coding for Irinotecan metabolizing enzymes and transporters of putative relevance. Patients were genotyped for variations in the genes encoding MDR1 P-glycoprotein (ABCB1), multidrug resistance-associated proteins MRP-1 (ABCC1) and MRP-2 (ABCC2), breast cancer resistance protein (ABCG2), cytochrome P450 isozymes (CYP3A4, CYP3A5), carboxylesterases (CES1, CES2), UDP glucuronosyl-transferases (UGT1A1, UGT1A9), and the hepatic transcription factor TCF1. The phenotypic data that is associated with the genetic sequence data for this study is described in Table 8.

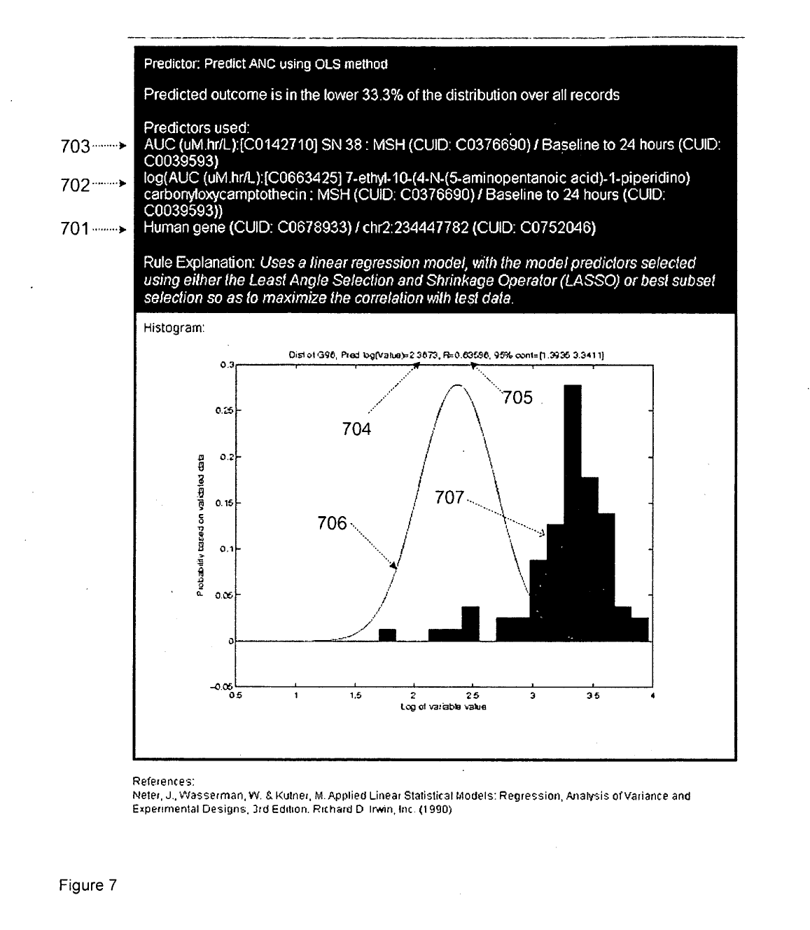

FIG. 7 illustrates a model of prediction outcome for colon cancer treatment with irinotecan given the available PharmGKB data that was submitted using the pharmacogenomic translation engine. In FIG. 7, the model selected a UGT1A1 genetic loci 701, the log of CPT-11 area-under-the concentration curve (AUC) from 0-24 hours 702 and the log of SN-38 AUC from 0-24 hours 703 to predict the log of the Nadir of Absolute Neutrophil Count from day 12 to day 14 704. Cross-validating the model with test data, a correlation coefficient of R=64% was achieved 705. The empirical standard deviation of the model prediction is shown 706 superimposed against the histogram of outcomes that were used to train the model 707. These statistics can be used to make an informed treatment decision, such as to forgo irinotecan treatment completely or to administer a second drug, such as granulocyte colony stimulating factor, to prevent a low ANC and resultant infections.

Enhanced Diagnostic Reporting

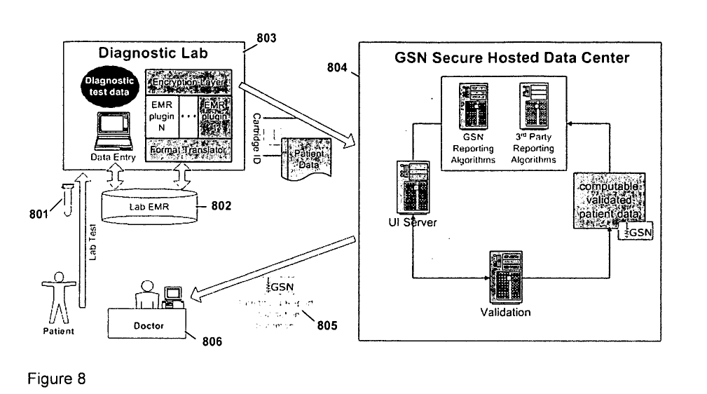

In the context of disease treatment, the generated phenotypic data is of most use to a clinician who can use the data to aid in selecting a treatment regimen. In one aspect, the phenotypic predictions will be contextualized and organized into a report for the clinician or patient. In another aspect, the system and method disclosed herein could be used as part of a larger system (see FIG. 8) wherein a diagnostic lab 803 validates data from lab tests 801 and medical reports 802, and sends it to a data center 804 where it is integrated into a standard ontology, analyzed using the disclosed method, and an enhanced diagnostic report 805 could be generated and sent to the physician 806.

One possible context in which a report may be generated would be related to predicting clinical outcomes for colon cancer patients being treated with irinotecan. It may take into consideration concepts such as contraindications for treatment, dosing schedules, side effect profiles. Examples of such side effects include myelosuppression and late-onset diarrhea which are two common, dose-limiting side effects of irinotecan treatment which require urgent medical care. In addition, severe neutropenia and severe diarrhea affect 28% and 31% of patients, respectively. Certain UGT1A1 alleles, liver function tests, past medical history of Gilbert's Syndrome, and identification of patient medications that induce cytochrome p450, such as anti-convulsants and some anti-emetics, are indicators warranting irinotecan dosage adjustment.

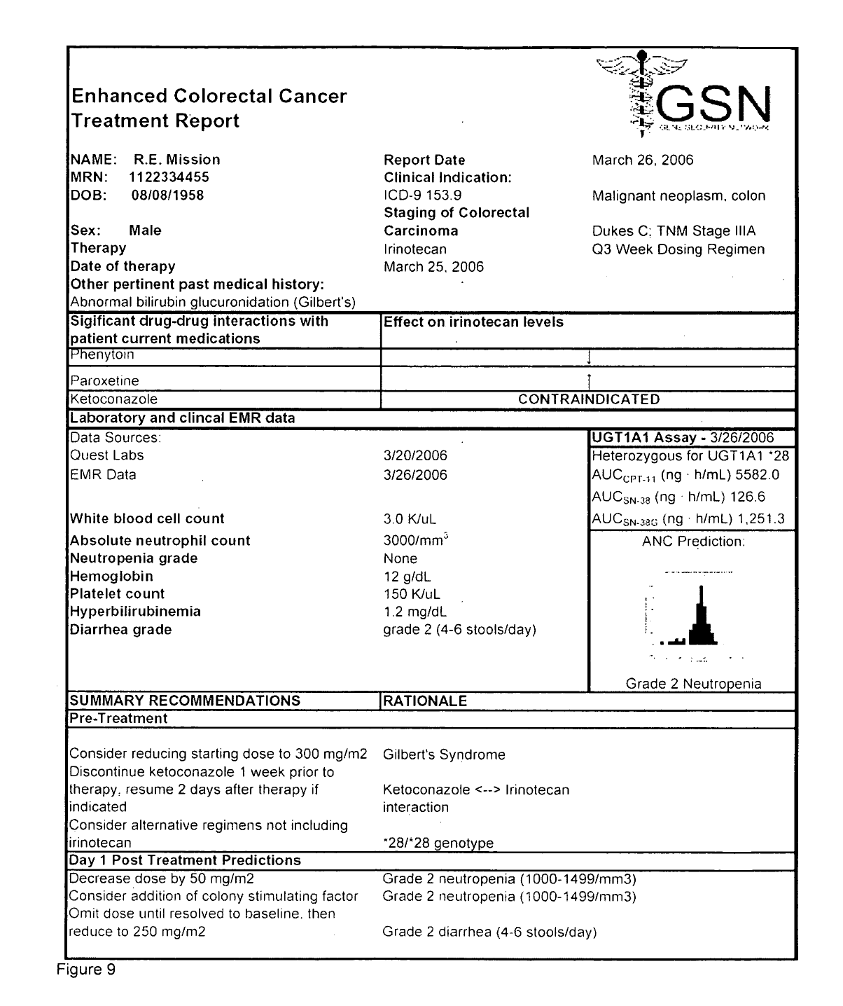

FIG. 9 is a mock-up of an enhanced report for colorectal cancer treatment with irinotecan that makes use of phenotype prediction. Prior to treatment, the report takes into account the patient's cancer stage, past medical history, current medications, and UGT1A1 genotype to recommend drug dosage. Roughly one data after the first drug dosage, the report includes a prediction of the expected Nadir of the patient's absolute neutrophil count in roughly two weeks time, based on the mutations in the UGT1A1 gene and metabolites (e.g. SN-38, CPT-11) measured from the patient's blood. Based on this prediction, the doctor can make a decision whether to give the patient colony stimulating factor drugs, or change the Irinotecan dosage. The patient is also monitored for blood counts, diarrhea grade. Data sources and justification for recommendations are provided.

Combinations of the Aspects

As noted previously, given the benefit of this disclosure, other aspects, features and embodiments may implement one or more of the methods and systems disclosed herein. Below is a short list of examples illustrating situations in which the various aspects of the disclosed invention can be combined in a plurality of ways. It is important to note that this list is not meant to be comprehensive, many other combinations of the aspects, features and embodiments of this invention are possible.

One example could be a situation in which a non-linear model using Support Vector Machine with radial basis kernel functions and a norm loss function utilizes genetic and phenotypic data of a human adult to predict the likelihood of early onset Alzheimer's disease, and to suggest possible lifestyle changes and exercise regimens which may delay the onset of the disease.

Another example could be a situation in which a linear model using the LASSO technique utilizes the genetic and phenotypic data of an adult woman afflicted with lung cancer, along with genetic data of the cancer to generate a report for the woman's physicians predicting which pharmaceuticals will be most effective in delaying the progression of the disease.

Another example could be a situation in which a plurality of models are tested on aggregated data consisting of genetic, phenotypic and clinical data of Crohn's disease patients, and then the non-linear regression model that is found to be the most accurate utilizes the phenotypic and clinical data of an adult man to generate a report suggesting certain nutritional supplements that are likely to alleviate the symptoms of his Crohn's disease.

Another example could be a situation in which a model utilizing contingency tables built from data acquired through the Hapmap project, and utilizing genetic information gathered from a blastocyst from an embryo are used to make predictions regarding likely phenotypes of a child which would result if the embryo were implanted.

Another example could be a situation where linear regression models utilizing genetic information of the strain of HIV infecting a newborn are used to generate a report for the baby's physician suggesting which antiretroviral drugs give her the greatest chance of reaching adulthood if administered.

Another example could be a situation where a new study is published suggesting certain correlations between the prevalence of myocardial infarctions in middle aged women and certain genetic and phenotypic markers. This then prompts the use of a non-linear regression model to reexamine the aggregate data of middle aged data, as well as genetic and phenotypic data of identified individuals whose data is known to the system, and the model then identifies those women who are most at risk of myocardial infarctions, and generates reports that are sent to the women's respective physicians informing them of the predicted risks.

Another example could be a situation where a plurality of models are tested on aggregated data of people suffering from colon cancer, including the various drug interventions that were attempted. The model that is found to allow the best predictions is used to identify the patients who are most likely to benefit from an experimental new pharmaceutical, and those results are used by the company which owns the rights to the new pharmaceutical to aid them in conducting their clinical trials.

What is claimed is:

1. A method for making predictions regarding phenotypic outcomes of an individual, the method comprising:
constructing models based on convex optimization techniques that enable continuous subset selection of independent variables; and
applying the constructed models to make the predictions by operating on data pertaining to the individual.

2. The method of claim 1, wherein the act of building models comprises building linear regression models.

3. The method of claim 1, wherein the act of building models comprises building non-linear regression models.

4. The method of claim 1, wherein the act of building models comprises using a cost function that corresponds in part to the degree of complexity of the model so that a sparse parameter model is created

5. The method of claim 1 wherein the accuracy of the model employing multiple independent variables can be improved using outcome data where only a subset of those independent variables was measured.

6. A method for making predictions regarding an individual, the method comprising:
constructing models based on contingency tables built from publicly available information about gene-disease associations; and
applying models to make the predictions by operating on data pertaining to the individual.

7. The method of claim 6, wherein an accuracy of the contingency tables that employ multiple independent variables can be refined using outcome data where only a subset of those independent variables was measured.

8. The method of claim 6, wherein an accuracy of the contingency tables that employ multiple independent variables can be refined using data about the association of the independent variables

9. The method of claim 6, wherein an accuracy of the contingency tables that employ multiple independent variables can be refined using data about the frequency of occurrence of certain values of the independent variables.

10. A method for making predictions regarding a first individual, the method comprising:
creating and testing a plurality of models using aggregated data from a second set of individuals for whom the outcome to be predicted is known;
calculating the relative accuracies of the various models for making the prediction given the data available on the first individual; and
using the model that is identified as the most accurate to make a prediction for the first individual.

11. The method of claim 1, where the type of data pertaining to the individual comprises data taken from a group consisting of the individual's genotypic data, the individual's phenotypic data, the individual's clinical, and the individual's laboratory data.

12. The method of claim 6, where the type of data pertaining to the individual comprises data taken from a group consisting of the individual's genotypic data, the individual's phenotypic data, the individual's clinical data, and the individual's laboratory data.

13. The method of claim 10, where the type data pertaining to the individual comprises data taken from a group consisting of the individual's genotypic data, the individual's phenotypic data, and the individual's clinical data, and the individual's laboratory data.

14. The method of claim 1, where the type of data also consists of data of a pathogen infecting the individual

15. The method of claim 1, where the type of data consists of genetic data related to an HIV virus infecting the individual

16. The method of claim 6, where the type of data also consists of data of a pathogen infecting the individual.

17. The method of claim 10, where the type of data also consists of data of a pathogen infecting the individual.

18. The method of claim 1, where said predictions concern topics selected from the group consisting of the individual's phenotypes, phenotype susceptibilities, possible clinical outcomes, lifestyle decisions, physical exercise, mental exercise, dietary habits, hormonal supplements, nutritional supplements, treatments for a disease, treatments for a pathogen, treatments for an undesirable condition, treatments with pharmaceuticals, and combinations thereof.

19. The method of claim 6, where said predictions concern topics selected from the group consisting of the individual's phenotypes, phenotype susceptibilities, possible clinical outcomes, lifestyle decisions, physical exercise, mental exercise, dietary habits, hormonal supplements, nutritional supplements, treatments for a disease, treatments for a pathogen, treatments for an undesirable condition, treatments with pharmaceuticals, and combinations thereof.

20. The method of claim 10, where said predictions concern topics selected from the group consisting of the individual's phenotypes, phenotype susceptibilities, possible clinical outcomes, lifestyle decisions, physical exercise, mental exercise, dietary habits, hormonal supplements, nutritional supplements, treatments for a disease, treatments for a pathogen, treatments for an undesirable condition, treatments with pharmaceuticals, and combinations thereof.

21. The method of claim 1, where said predictions are used to generate a report for the individual or for an agent of the individual.

22. The method of claim 6, where said predictions are used to generate a report for the individual or for an agent of the individual.

23. The method of claim 10, where said predictions are used to generate a report for the individual or for an agent of the individual.

24. The method of claim 1, wherein the act of operating comprises operating on new data to update the individual's predictions where the data is taken from a group comprising new research data or new aggregated data on other subjects.

25. The method of claim 6, wherein the act of operating comprises operating on new data to update the individual's predictions where the data is taken from a group comprising new research data or new aggregated data on other subjects.

26. The method of claim 10, wherein the act of operating comprises operating on new data to update the individual's predictions where the data is taken from a group comprising new research data or new aggregated data on other subjects.

27. A system configured to accomplish the method of claim 1.

28. A system configured to accomplish the method of claim 6.

29. A system configured to accomplish the method of claim 10.
